(19) United States
(12) Patent Application Publication
(10) Pub. No.: US 2014/0068659 A1
(43) Pub. Date: Mar. 6, 2014

(54) COMPUTER-IMPLEMENTED METHODS AND COMPUTER SYSTEMS FOR COMBINING MULTICHANNEL CONTENT PRESENTATION WITHIN INTERACTIVE LOTTERY/GAMING ENVIRONMENT IN AN INTERACTIVE PRESENTATION DEVICE OF A LOTTERY/GAME OPERATOR

(71) Applicants: Manolis Vasilikakis, Athens (GR); Pier Gaston, Athens (GR); Vasilliki Gianekuo, Athens (GR); Dimitris Giokas, Athens (GR); Spiros Grigoropoulos, Athens (GR); Babis Karathanasis, Athens (GR); Christos Pasalidis, Athens (GR); Athanasios Staveris, Athens (GR)

(72) Inventors: Manolis Vasilikakis, Athens (GR); Pier Gaston, Athens (GR); Vasilliki Gianekuo, Athens (GR); Dimitris Giokas, Athens (GR); Spiros Grigoropoulos, Athens (GR); Babis Karathanasis, Athens (GR); Christos Pasalidis, Athens (GR); Athanasios Staveris, Athens (GR)

(21) Appl. No.: 14/014,194

(22) Filed: Aug. 29, 2013

Related U.S. Application Data
(60) Provisional application No. 61/694,491, filed on Aug. 29, 2012.

(51) Int. Cl. H04N 21/478

(52) U.S. Cl. CPC H04N 21/4781
USPC 725/32; 725/60

(57) ABSTRACT

In some embodiments, the instant invention provides for a computer-implemented method having at least the following: presenting, by a specialized interactive presentation device, to a user, a touchscreen divided into: a first function area, a second function area, and a third function area; where the specialized interactive presentation device is located at a physical establishment that provides gaming, lottery, or both; where the first function area, the second function area, and the third function area are configured to function independently from each other and concurrently with each other; displaying, by the specialized interactive presentation device, in the first function area, advertisement content related to lottery, gaming, or both; displaying, by the specialized interactive presentation device, in the second function area, event content for a live or stored event; displaying, by the specialized interactive presentation device, in the third function area, an interactive non-lottery game, an interactive lottery game, or both.

### RELATED APPLICATIONS

This application claims the priority of U.S. provisional application Ser. No. 61/694,491, filed Aug. 29, 2012 which is incorporated herein by reference in its entirety for all purposes.

### TECHNICAL FIELD

In some embodiments, the instant invention is related to computer-implemented methods and computer systems for combining multichannel content presentation within interactive lottery/gaming environment in an interactive presentation device of a lottery/game operator.

### BACKGROUND OF INVENTION

Generally, the popularity of gaming and/or lottery terminals, such as lottery waging machines, slot machines, video poker machines, and the like such terminals among players can depend on the perceived likelihood of winning money at the terminal and the intrinsic entertainment value of the terminal relative to other available options. Where the available options include a number of competing terminals and the expectation of winning each terminal is roughly the same (or believed to be the same), typically, players are most likely to be attracted to the more entertaining and exciting of the terminals.

### BRIEF SUMMARY OF INVENTION

In some embodiments, the instant invention provides for a computer-implemented method that that includes at least the following steps of: presenting, by a specialized interactive presentation device, to a user, a touchscreen divided into: i) at least one first function area, ii) at least one second function area, and iii) at least one third function area; where the specialized interactive presentation device is located at a physical establishment that provides gaming, lottery, or both; where the at least one first function area, the at least one second function area, and the at least one third function area are configured to function independently from each other and concurrently with each other; displaying, by the specialized interactive presentation device, in the at least one first function area, advertisement content related to lottery, gaming, or both; displaying, by the specialized interactive presentation device, in the at least one second function area, event content for at least one live or stored event; displaying, by the specialized interactive presentation device, in the at least one third function area, at least one interactive non-lottery game, at least one interactive lottery game, or both; enabling, by the specialized interactive presentation device, the user to interact with the at least one second function area to select the event content to be displayed by the at least one second function area; where the at least one second function area is configured to receive from the user selections related to the event content, by recognizing at least one of: i) the user's touches of the touchscreen within the at least one second function area, and ii) at least one first gesture by the user related to the user's interaction with the at least one second function area; enabling, by the specialized interactive presentation device, the user to interact with the at least one third function area to play the at least one interactive non-lottery game, at least one interactive lottery game, or both; and where the at least one third function area is configured to receive from the user selections related to the at least one interactive non-lottery game, at least one interactive lottery game, or both, by recognizing at least one of: i) the user's touches of the touchscreen within the at least one third function area, and ii) at least one second gesture by the user related to the user's interaction with the at least one third function area.

In some embodiments, the method can further include personalizing for the user, by the specialized interactive presentation device, at least one of the following: i) the advertisement content, ii) the event content, iii) the at least one interactive non-lottery game, and iv) at least one interactive lottery game.

In some embodiments, the personalizating is based, at least in part, on stored profile information about the user.

In some embodiments, the personalizating is based, at least in part, on identifying data received, by the specialized interactive presentation device, from the user when the user interacts with the specialized interactive presentation device.

In some embodiments, the specialized interactive presentation device receives the identifying data, by utilizing at least one of the following: i) the touchscreen, ii) at least one camera, and iii) at least one module recognizing wireless information transmission.

In some embodiments, the at least one module is a near-field communication (NFC) reader.

In some embodiments, the personalizating is based, at least in part, on a specific interactive lottery game, a specific interactive non-lottery game, or both which the user presently plays or previously played.

In some embodiments, the method can further includes step of: combining, by the specialized interactive presentation device, at least one first content element received from at least one remote source with at least one second content element generated by the specialized interactive presentation device to create at least one of the following: i) the advertisement content, ii) the event content, iii) the at least one interactive non-lottery game, and iv) at least one interactive lottery game.

In some embodiments, the at least one second content element is generated by the specialized interactive presentation device based, at least in part, on one of the following: i) stored profile information about the user, ii) identifying data received, by the specialized interactive presentation device, from the user, and iii) at least one first interaction between the user and the specialized interactive presentation device.

In some embodiments, the event is a sport game. In some embodiments, the at least one interactive non-lottery game is a peer-to-peer game. In some embodiments, the at least one interactive lottery game is a fast number lottery game. In some embodiments, the fast number lottery game is Keno.

In some embodiments, the instant invention provides for a computer-implemented system that includes at least the following components/modules: at least one specialize computer machine, comprising: a non-transient memory having at least one region for storing particular computer executable program code; and at least one processor for executing the particular program code stored in the memory, wherein the particular program code is configured to at least perform the following operations: presenting, by a specialized interactive presentation device, to a user, a touchscreen divided into: i) at least one first function area, ii) at least one second function area, and iii) at least one third function area; where the specialized interactive presentation device is located at a physical establishment that provides gaming, lottery, or both; where the at least one first function area, the at least one second function area, and the at least one third function area are configured to function independently from each other and concurrently with each other; displaying, by the specialized interactive presentation device, in the at least one first function area, advertisement content related to lottery, gaming, or both; displaying, by the specialized interactive presentation device, in the at least one second function area, event content for at least one live or stored event; displaying, by the specialized interactive presentation device, in the at least one third function area, at least one interactive non-lottery game, at least one interactive lottery game, or both; enabling, by the specialized interactive presentation device, the user to interact with the at least one second function area to select the event content to be displayed by the at least one second function area; where the at least one second function area is configured to receive from the user selections related to the event content, by recognizing at least one of: i) the user's touches of the touchscreen within the at least one second function area, and ii) at least one first gesture by the user related to the user's interaction with the at least one second function area; enabling, by the specialized interactive presentation device, the user to interact with the at least one third function area to play the at least one interactive non-lottery game, at least one interactive lottery game, or both; and where the at least one third function area is configured to receive from the user selections related to the at least one interactive non-lottery game, at least one interactive lottery game, or both, by recognizing at least one of: i) the user's touches of the touchscreen within the at least one third function area, and ii) at least one second gesture by the user related to the user's interaction with the at least one third function area.

### BRIEF DESCRIPTION OF THE FIGURES

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

FIG. 1 illustrates an illustrative example in accordance with some embodiments of the present invention.

FIG. 2 illustrates another illustrative example in accordance with some embodiments of the present invention.

FIGS. 3A-3D are screenshots that illustrate examples in accordance with some embodiments of the present invention.

FIG. 4 is a screenshot that illustrates another example in accordance with some embodiments of the present invention.

FIGS. 5A-5E illustrate examples in accordance with some embodiments of the present invention.

FIG. 6 is a screenshot that illustrates another example in accordance with some embodiments of the present invention.

FIGS. 7A-7B are screenshots that illustrate examples in accordance with some embodiments of the present invention.

FIGS. 8A-8E are screenshots that illustrate examples in accordance with some embodiments of the present invention.

FIGS. 9A-9H are screenshots that illustrate examples in accordance with some embodiments of the present invention.

FIG. 10 is a screenshot that illustrates another example in accordance with some embodiments of the present invention.

FIG. 11 is a screenshot that illustrates yet another example in accordance with some embodiments of the present invention.

FIGS. 12A-12B are screenshots that illustrate examples in accordance with some embodiments of the present invention.

FIG. 13 illustrates another illustrative example in accordance with some embodiments of the present invention.

FIG. 14 illustrates yet another illustrative example in accordance with some embodiments of the present invention.

In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

### DETAILED DESCRIPTION OF INVENTION

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive. Any alterations and further modifications of the inventive feature illustrated herein, and any additional applications of the principles of the invention as illustrated herein, which would normally occur to one skilled in the relevant art and having possession of this disclosure, are to be considered within the scope of the invention.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Illustrative Operating Environments

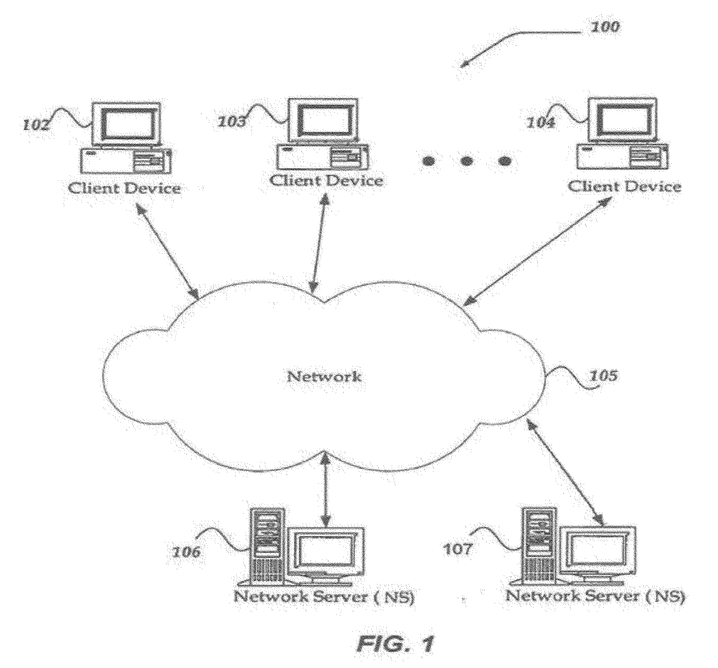

FIG. 1 illustrates one embodiment of an environment in which the present invention may operate. However, not all of these components may be required to practice the invention, and variations in the arrangement and type of the components may be made without departing from the spirit or scope of the invention. In some embodiments, the inventive system and method may include a large number of members and/or concurrent transactions. In other embodiments, the inventive system and method are based on a scalable computer and network architecture that incorporates varies strategies for assessing the data, caching, searching, and database connection pooling. An example of the scalable architecture is an architecture that is capable of operating multiple servers.

In embodiments, members of the inventive computer system 102-104 (e.g. vending machines) include virtually any computing device capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, client devices 102-104 are any device that is capable of connecting using a wired or wireless communication medium such as a PDA, POCKET PC, wearable computer, and any other device that is equipped to communicate over a wired and/or wireless communication medium.

In embodiments, each member device within member devices 102-104 may include a browser application that is configured to receive and to send web pages, and the like. In embodiments, the browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In embodiments, the invention is programmed in either Java, .Net, QT, C, C++ or other suitable programming language.

In embodiments, member devices 102-104 may be further configured to receive a message from another computing device employing another mechanism, including, but not limited to email, Short Message Service (SMS), Multimedia Message Service (MMS), instant messaging (IM), internet relay chat (IRC), mIRC, Jabber, and the like or a Proprietary protocol.

In embodiments, network 105 may be configured to couple one computing device to another computing device to enable them to communicate. In some embodiments, network 105 may be enabled to employ any form of computer readable media for communicating information from one electronic device to another. Also, in embodiments, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router may act as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in some embodiments, remote computers and other related electronic devices could be remotely connected to either LANs or WANs via a modem and temporary telephone link. In essence, in some embodiments, network 105 includes any communication method by which information may travel between client devices 102-104, and servers 106 and 107.

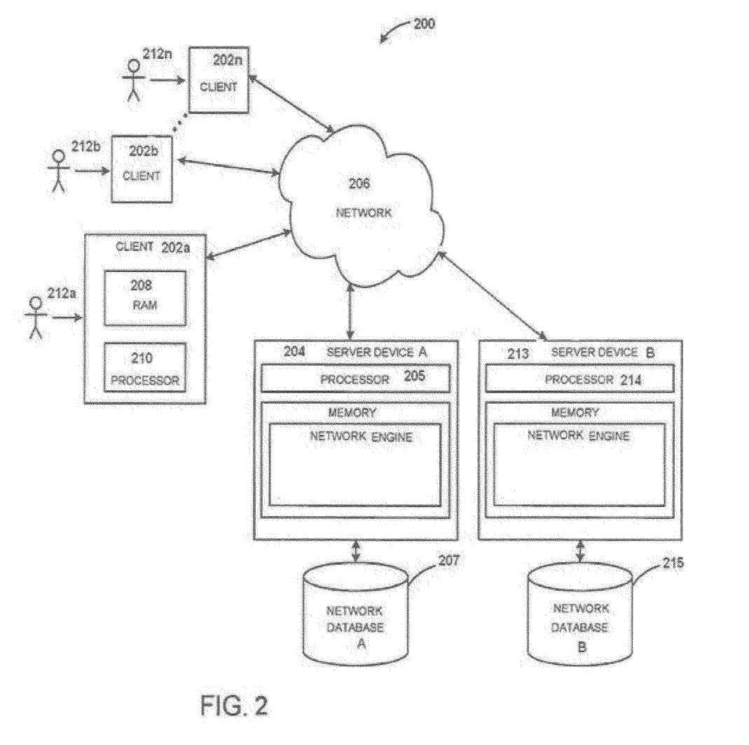

FIG. 2 shows another exemplary embodiment of the computer and network architecture that supports the inventive method and system. The member devices 202a, 202b thru 202n shown (e.g., vending machines) each at least includes a computer-readable medium, such as a random access memory (RAM) 208 coupled to a processor 210 or FLASH memory. The processor 210 may execute computer-executable program instructions stored in memory 208. Such processors comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media may include, but are not limited to, an electronic, optical, magnetic, or other storage or transmission device capable of providing a processor, such as the processor 210 of client 202a, with computer-readable instructions. Other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Member devices 202a-n may also comprise a number of external or internal devices such as a mouse, a CD-ROM, DVD, a keyboard, a display, a touch screen, or other input or output devices. Examples of client devices 202a-n may be personal computers, digital assistants, personal digital assistants, cellular phones, mobile phones, smart phones, pagers, digital tablets, laptop computers, Internet appliances, and other processor-based devices. In general, a client device 202a can be any type of processor-based platform that is connected to a network 206 and that interacts with one or more application programs. Client devices 202a-n may operate on any operating system capable of supporting a browser or browser-enabled application, such as Microsoft™, Windows™, Linux, Android or iOS. The client devices 202a-n shown may include, for example, personal computers executing a browser application program such as Microsoft Corporation's Internet Explorer™, Apple Computer, Inc.'s Safari™, Mozilla Firefox, and Opera. Through the client devices 202a-n, users (e.g. players, agents, etc.) 212a-n communicate over the network 206 with each other and with other systems and devices coupled to the network 206. As shown in FIG. 2, server devices 204 and 213 may be also coupled to the network 206.

In some embodiments, the term “mobile electronic device” may refer to any portable electronic device that may or may not be enabled with location tracking functionality. For example, a mobile electronic device can include, but is not limited to, a mobile phone, Personal Digital Assistant (PDA), Blackberry™, Pager, Smartphone, tablet computer, or any other reasonable mobile electronic device. For ease, at times the above variations are not listed or are only partially listed, this is in no way meant to be a limitation.

In some embodiments, the terms “proximity detection,” “locating,” “location data,” “location information,” and “location tracking” as used herein may refer to any form of location tracking technology or locating method that can be used to provide a location of a mobile electronic device, such as, but not limited to, at least one of location information manually input by a user, such as, but not limited to entering the city, town, municipality, zip code, area code, cross streets, or by any other reasonable entry to determine a geographical area; Global Positions Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed, this is in no way meant to be a limitation.

In some embodiments, near-field wireless communication (NFC) can represent a short-range wireless communications technology in which NFC-enabled devices are “swiped,” “bumped,” “tap” or otherwise moved in close proximity to communicate. In some embodiments, NFC could include a set of short-range wireless technologies, typically requiring a distance of 10 cm or less.

In some embodiments, NFC may operate at 13.56 MHz on ISO/IEC 18000-3 air interface and at rates ranging from 106 kbit/s to 424 kbit/s. In some embodiments, NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, NFC peer-to-peer communication can be conducted when a plurality of NFC-enable devices within close proximity of each other.

### Illustrative Examples of the Present Invention

In some embodiments, the single interactive presentation device of the instant invention represents an interactive gaming device for lottery retail environments and at the same time a gaming framework.

In some embodiments, while the single interactive presentation device of the instant invention can be managed by a lottery operator and/or a retail lottery establishment, the single interactive presentation device of the instant invention can provide personalization features to users/players, through identification via tokens and/or build-in devices (e.g., including but not limited to, a camera, a NFC reader, etc.).

In some embodiments, the single interactive presentation device of the instant invention seamlessly combines content elements from a distribution channel (e.g., including but not limited to, video streaming from IPTV, Satellite/Cable/Terrestrial, internet sources, etc.), and content locally created and/or rendered. In some embodiments, the combination of the content elements can be triggered by a central system of a lottery operator and/or by interaction(s) with a user/player.

In some embodiments, the single interactive presentation device of the instant invention allows, in lottery retail gaming environment, users/players to concurrently view a live game and participate in the game by placing their bets using the single interactive presentation device. In some embodiments, the single interactive presentation device of the instant invention is utilized for playing fast games (e.g., KENO, Monitor Games, Progressive Jackpot Games, Live Betting).

In some embodiments, the single interactive presentation device of the instant invention have a human-machine interface supporting interactive player navigation based on: (a) simple touch, multi touch, press and gestures, scrolling, moving to next item, accessing selection menus, “jumping”, sorting via the multi-touch screen, (b) text and voice-based search, and, (c) voice-based command and control.

In some embodiments, the single interactive presentation device of the instant invention allows for a “Lottery triple play” of at least the following activities performed concurrently or in different time instances: (a) lottery advertising (digital signage), (b) information on events/games (interactive digital signage), and (c) a rich variety of interactive games including sports betting, racing, number games, video-lottery, instant interactive games, casual games and peer-to-peer games, as dictated by a lottery operator.

In some embodiments, the single interactive presentation device of the instant invention can have camera(s) for:

(a) reading user/player's identification token(s) (e.g., including but not limited to, QR codes);

(b) face and/or body detection;

(c) face and/or body movement tracking;

(d) age and gender recognition;

(e) identity recognition.

In some embodiments, the single interactive presentation device of the instant invention can utilize at least the above (a)-(e) uses of the camera(s) in one or more of the following applications: (i) advanced player security, (ii) personalization of player environment, (iii) apply responsible gaming policies, (iv) direct marketing, and/or (v) marketing analytics.

In some embodiments, the single interactive presentation device of the instant invention can utilize camera(s) and microphone(s) for:

(a) video communications between the user/player and a support call center;

(b) peer-to-peer video communications between users/players engaged in peer-to-peer gaming.

In some embodiments, the single interactive presentation device of the instant invention allows cashless, paperless game participation based on secure player identification and/or central player account.

In some embodiments, displayed games and content support multimedia. In some embodiments, the multimedia may be high definition, 3D, and/or rich multimedia. In some embodiments the multimedia may include, but is not limited to, video and audio, images, animated images, graphics and/or texts. In some embodiments, the video and audio, images, animated images, graphics and/or texts may be combined in screen zones and/or blended in multiple graphics layers. In some embodiments, the multiple graphic layers can be delivered in real-time (live). In some embodiments, the multiple graphic layers may be delivered over internet protocol (“IP”) and/or Digital Video Broadcasting (“DVB”) and/or Web-enabled networks and/or be pre-stored on device storage.

In some embodiments, the content including video and audio, images, animated images, 3D or 2D graphics and texts that can be combined in screen zones or blended in multiple graphics layers, and that can be delivered in real-time (live) over IP or DVB or Web-enabled networks or be pre-stored on the device storage.

In some embodiments, the present invention includes methods and system for betting. In some embodiments the methods and system include self-service betting. In some embodiments, the methods and system may be combined with one or more digital signs. In some embodiments, the methods and system are designed for retail environments.

In some embodiments, the methods and system include device hardware, device software and/or protocols for gaming content display. In some embodiments, the methods and systems include device hardware, device software, and/or protocols for content navigation. In some embodiments, the methods and system allow for the combination of multiple functionalities. In some embodiments, the methods and system allow for multiple functionalities in retailer shop environments. In some embodiments, the retail shop environments include, but are not limited to, lottery, betting, racing, and/or video lottery venues. In some embodiments, the functionalities include, but are not limited to, digital signage applications, interactive digital signage applications, participation in games, participation in live games, and/or combinations thereof.

In some embodiments, the functionalities include, but are not limited to, digital signage applications. In some embodiments, the digital signage applications include generic digital signage. In some embodiments, the digital signage includes lottery, betting, racing and/or video lottery content display applications. In some embodiments, the content is delivered and/or managed centrally. In some embodiments, the content display is centrally controlled. In some embodiments, the content display is centrally controlled via a central management system.

In some embodiments, functionalities include, but are not limited to, interactive digital signage applications. In some embodiments, the interactive digital signage applications may include generic digital signage. In some embodiments, the interactive digital signage may include lottery, betting, racing and/or video lottery content display applications. In some embodiments, the interactive digital signage includes content delivered and/or managed centrally. In some embodiments, the content display may be controlled locally. In some embodiments, the locally controlled content display may be controlled through a human-machine interface. In some embodiments, the content display may be controlled centrally. In some embodiments, the content display may be controlled centrally through a central management system.

In some embodiments, the functionalities include, but are not limited to, participation in games. In some embodiments, the games include, but are not limited to, lottery, betting, racing, video lottery and/or casual games.

In some embodiments, the functionalities include, but are not limited to, participation in games with concurrent use of interactive digital signage applications. In some embodiments, one part of the screen allows for participation in one or more games while another part of the screen displays interactive information. In some embodiments, the games include, but are not limited to, lottery, betting, racing, video lottery and/or casual games. In some embodiments, the interactive digital signage applications content is related to the game offered to a participant. In some embodiments, the interactive digital signage applications content is independent of the game offered to a participant. In some embodiments, the use of the interactive digital signage applications content may be achieved by dynamic video and/or graphics scaling, split-screen management, and/or graphics overlays that may include one or more transparencies. In some embodiments, the content may be based on response to a participant interaction. In some embodiments, the content may be based on predefined scenarios.

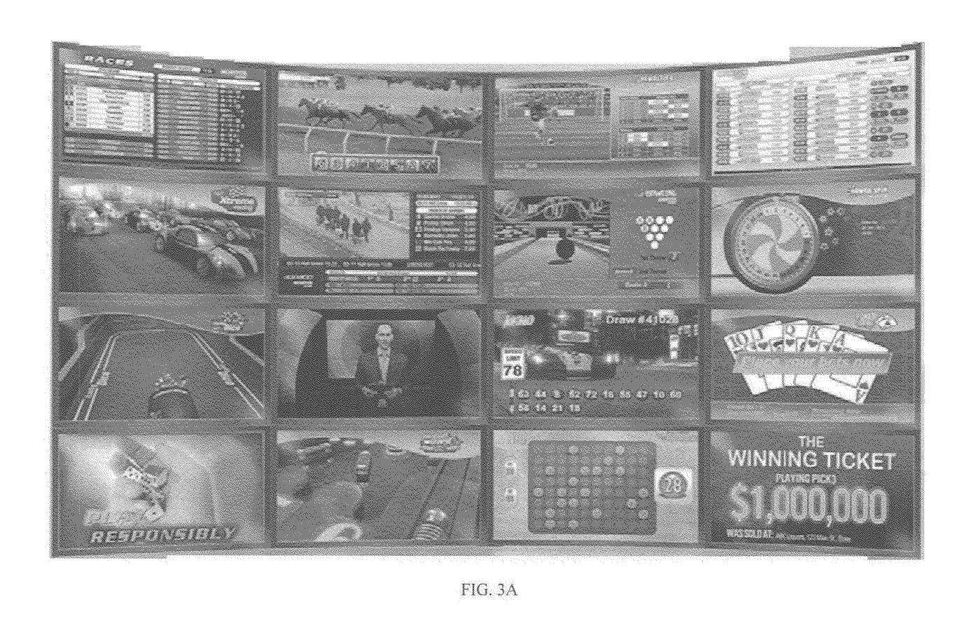

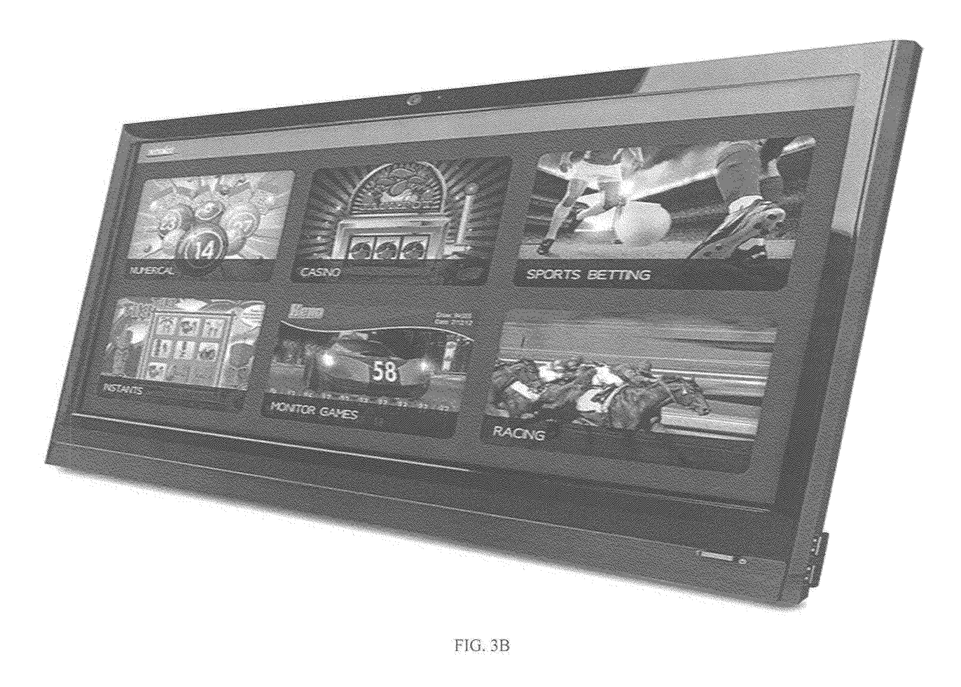

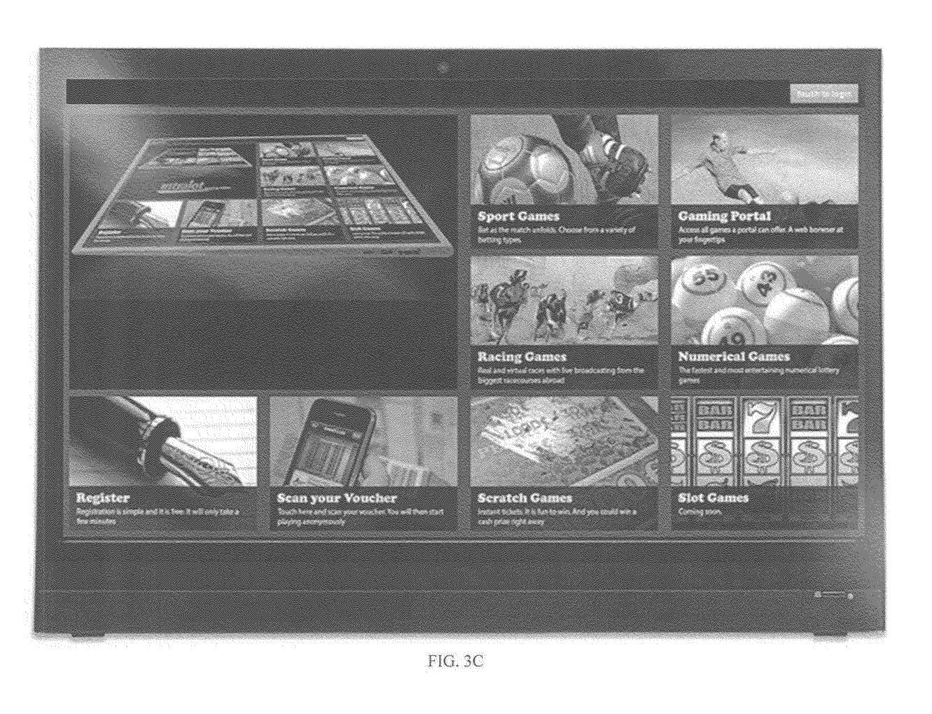

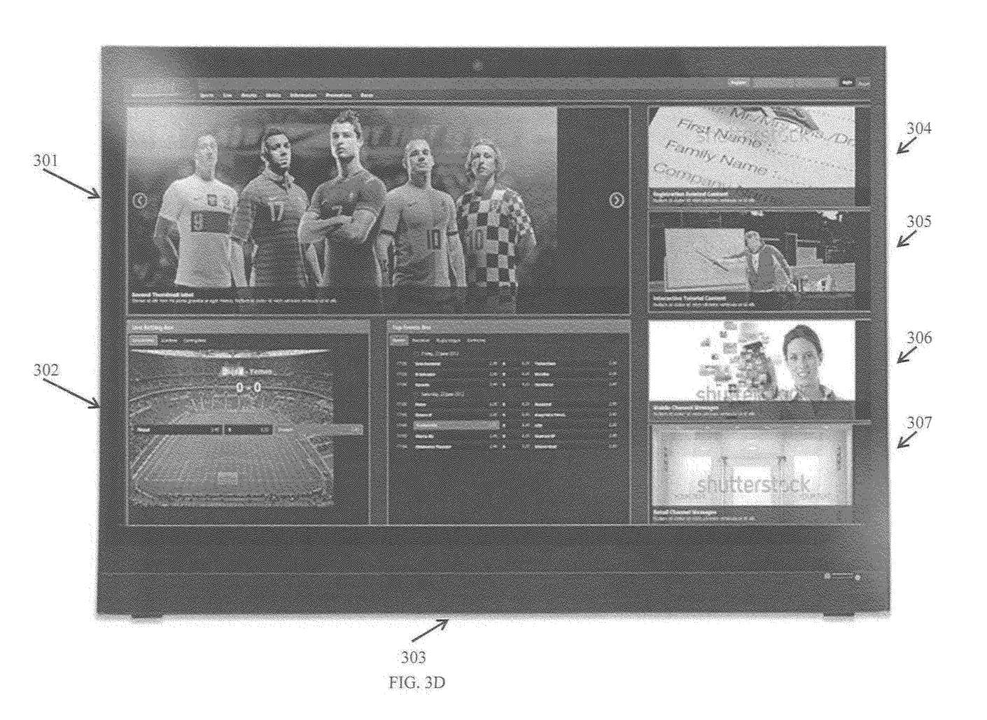

In some embodiments, as illustrated in FIGS. 3A-3D the live content, information related to the game, and/or area for participating in the game are located in different sections of the screen via one or more of dynamic video, graphics scaling, split-screen management, graphics overlays with transparencies or combinations thereof. In some embodiments, the dynamic video, graphics scaling, split-screen management, graphics overlays with transparencies and/or combinations thereof respond to user interaction. In other embodiments, the dynamic video, graphics scaling, split-screen management, graphics overlays with transparencies and/or combinations thereof are based on predefined scenarios. In some embodiments, as illustrated in FIG. 3C, the single interactive presentation device of the instant invention can have a gateway screen that would be split in a plurality of activity/content areas, such as, but are not limited to:
digital signage area(s) (a full screen or a window);
user/player registration/identification area(s);
event/game/betting area(s).

In some embodiments, as illustrated in FIG. 3D, the single interactive presentation device of the instant invention can have a screen that would split to have:

area(s) that display(s) information about live event(s) (301);

area(s) that show(s) the live event(s) (302);

area(s) for a user/player to interactively view information and/or play games (e.g., lottery games) (303); and

area(s) that display(s) digital signage (e.g., advertisements) (304-307).

In some embodiments, the single interactive presentation device of the instant invention have, for example, at least the following hardware/software capabilities:

21.5″ LCD touch screen: optical touch, dual finger;

Full high definition resolution: 1080p;

High performance: dual core processor @ 1.5 GHz, 1 GB RAM, 8 GB solid state storage, microSDHC card slot;

3D engine;

Android 4.1 (JB);

Low power consumption;

LAN, Wi-Fi, Bluetooth;

Camera 1.2 Mpixel, 720p;

Stereo speakers with SRS, Microphone, Headset port;

3xUSB, HDMI in;

Kensington Lock;

HTML5-enabled interactive software for Unified Gaming Experience across multi-channels/platforms (e.g., Internet, Mobile, Retail store, etc.).

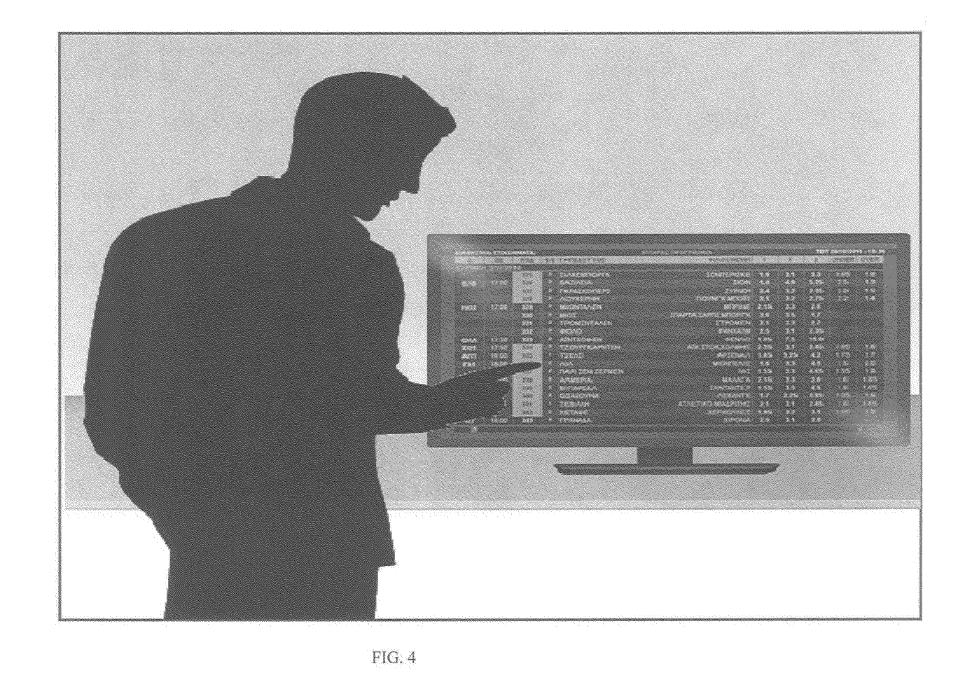

In some embodiments, as illustrated in FIG. 4, the formalities include participation in live games. In some embodiments, the live games may include, but are not limited to, lottery, betting, and/or racing. In some embodiments, as illustrated in FIG. 4, the instant invention combines digital signage with iTV to maximize player/user's interactive experience. In some embodiments, the single interactive presentation device of the instant invention can be a touchscreen based device for retailer-shop environments which combines/offers one or more of the following functionalities:

integrated tablet;

interactive digital signage;

paperless, cashless, ITV-like self-service gaming;

intuitive, gesture-based, tablet like navigation;

appealing content appearance;

slim and compact design;

LAN, Wi-Fi, Bluetooth, NFC-capabilities

a camera;

microphone and/or stereo speakers;

photo-frame stand, multiple mounting options (VESA);

variety of gaming/content applications.

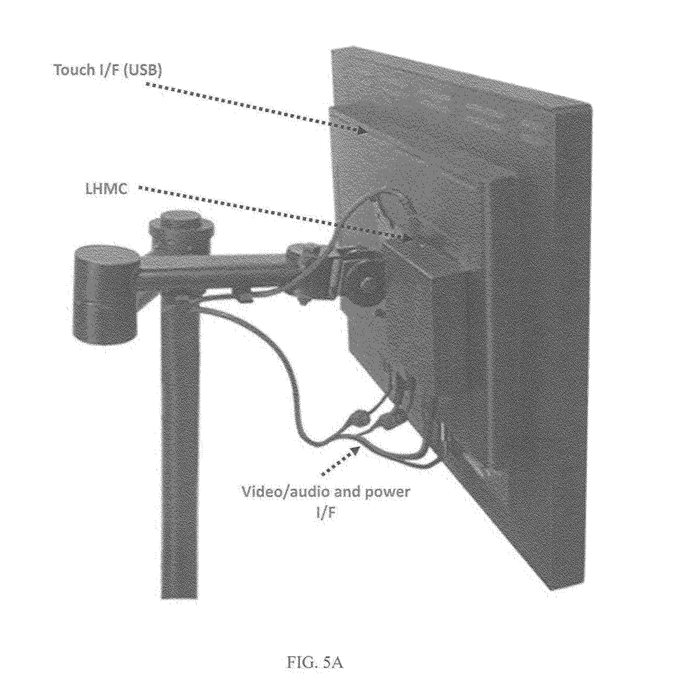

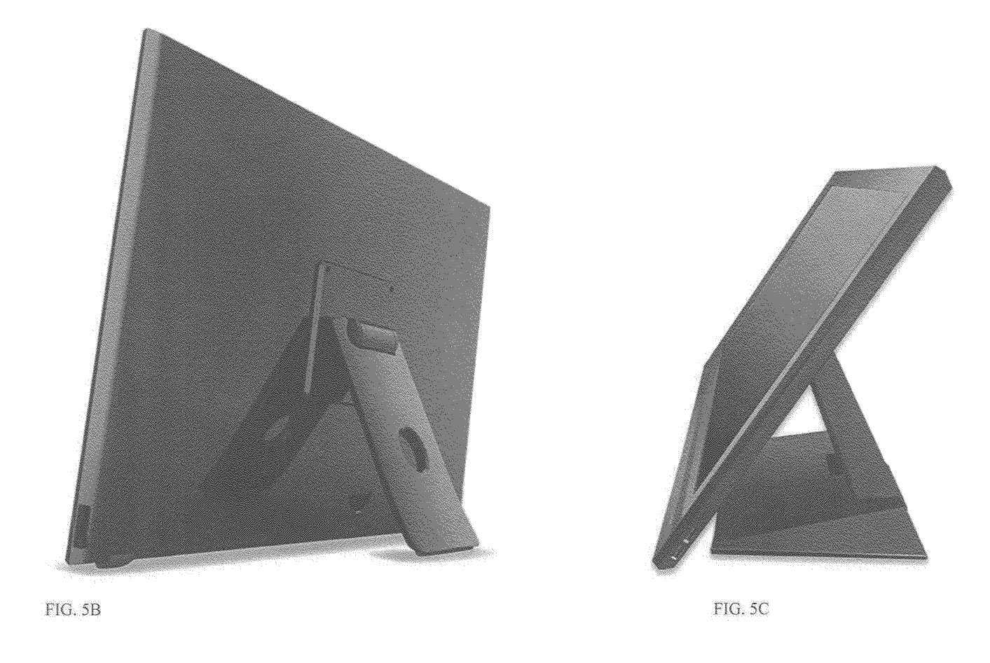

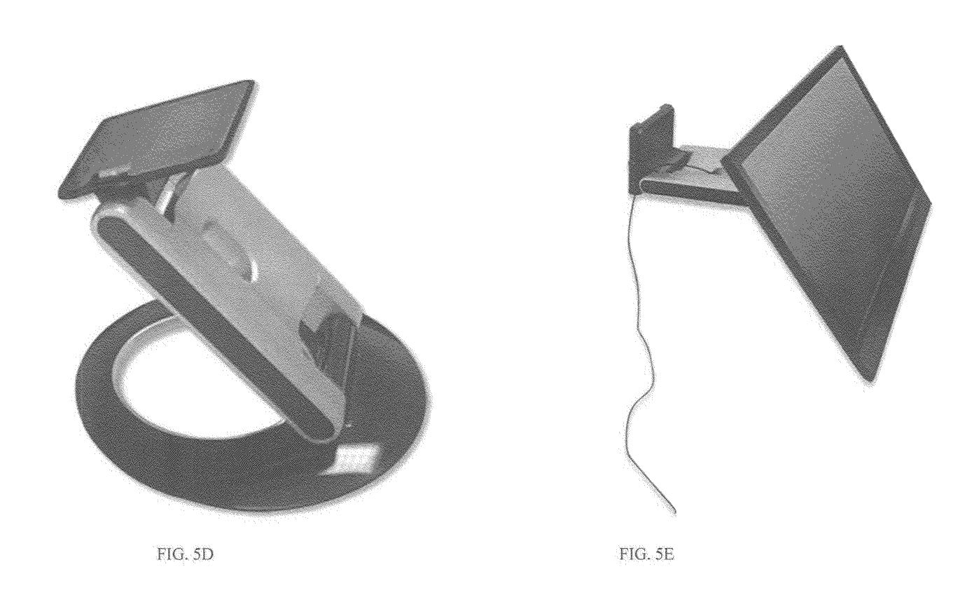

In some embodiments, the single interactive presentation device of the instant invention can be set-up as illustrated in FIGS. 5A-5E. In some embodiments, the single interactive presentation device of the instant invention can have discrete, minimal footprint, fit in any retailer shop, be mounted on a wall or a desktop (e.g., photo-frame stand, long pole, single or dual hinge stand, etc.).

In some embodiments, the single interactive presentation device of the instant invention can provide a plurality of capabilities for personalization of the player/user's interactive experience. In some embodiments, the interactive capabilities of the single interactive presentation device of the instant invention can include various combinations/selections out of the following features:

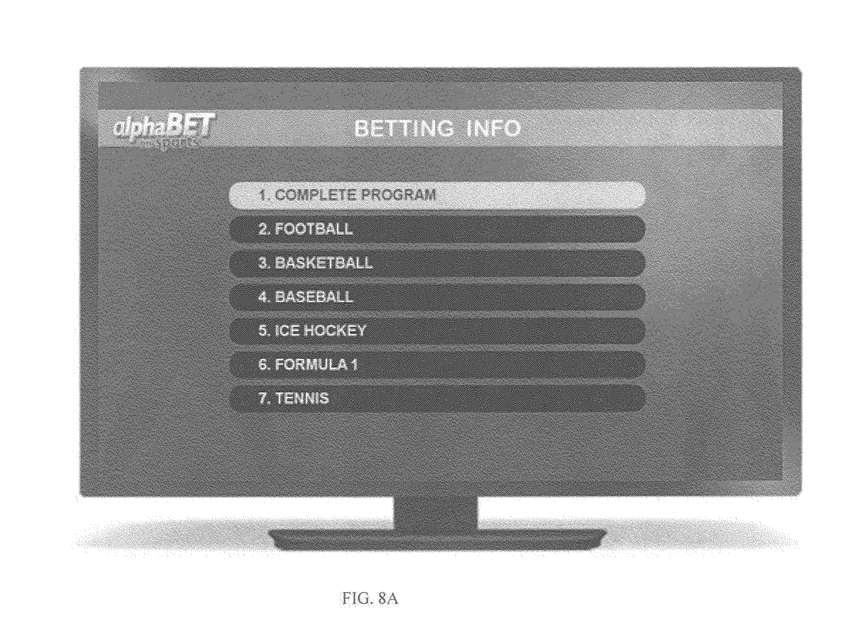

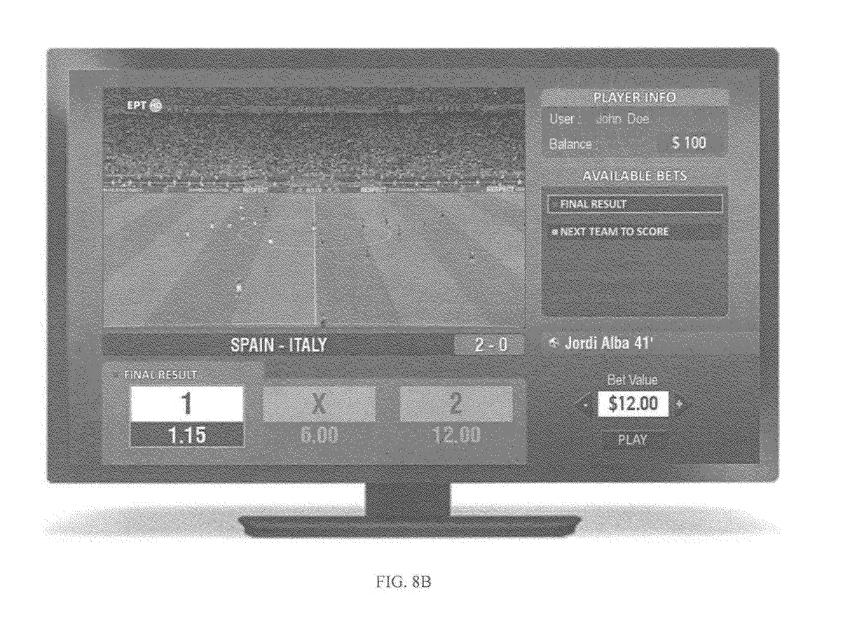

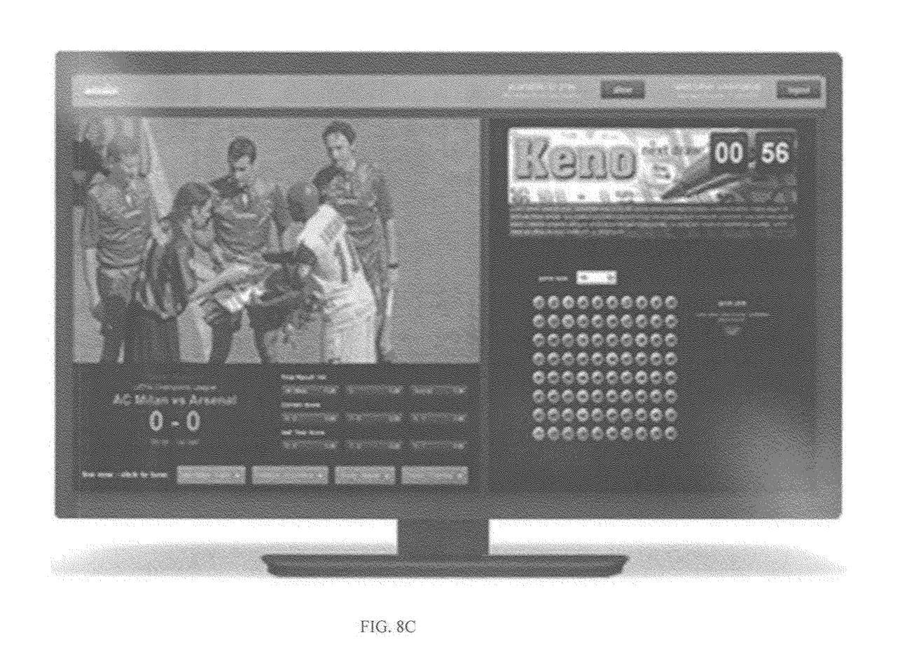

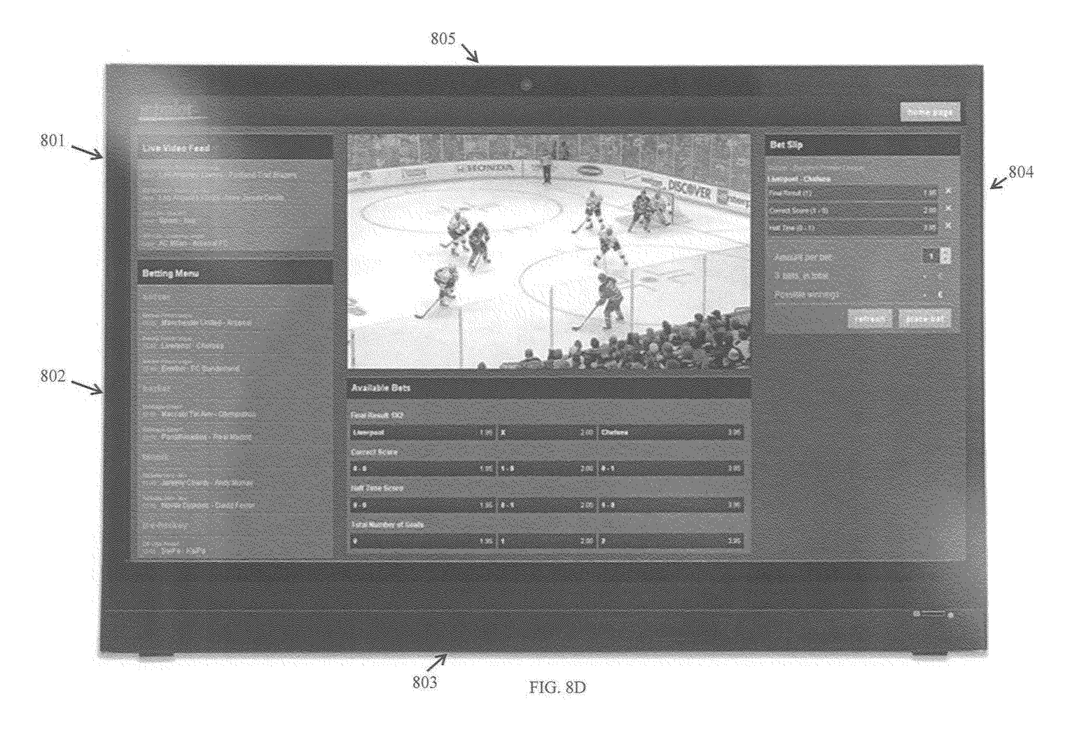

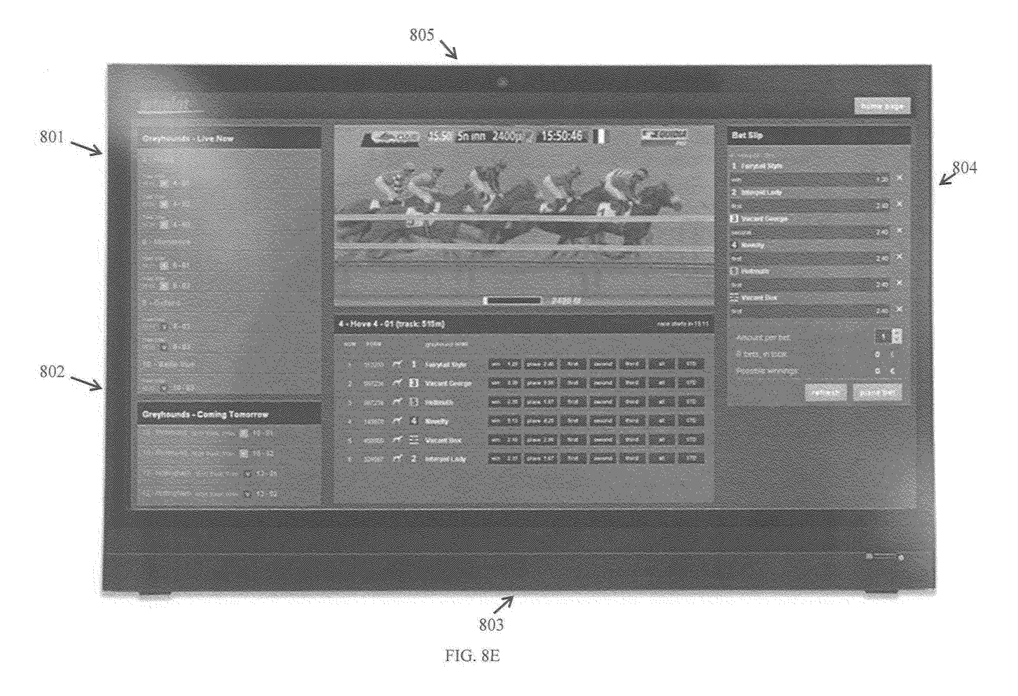

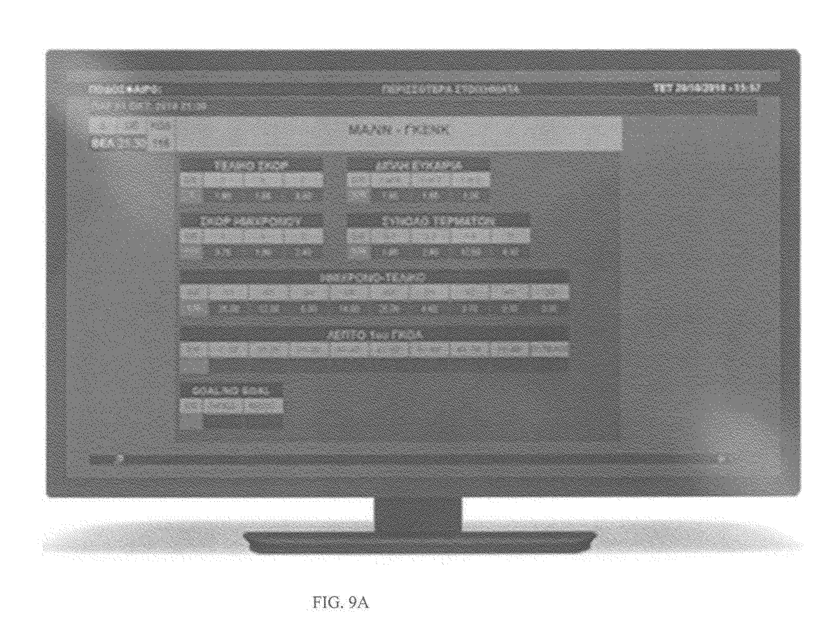

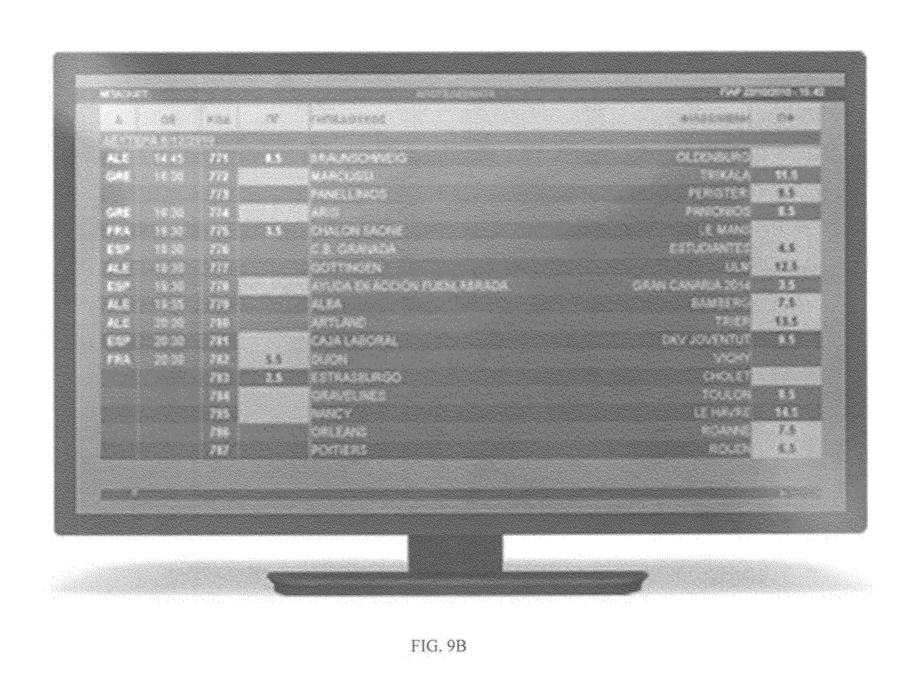

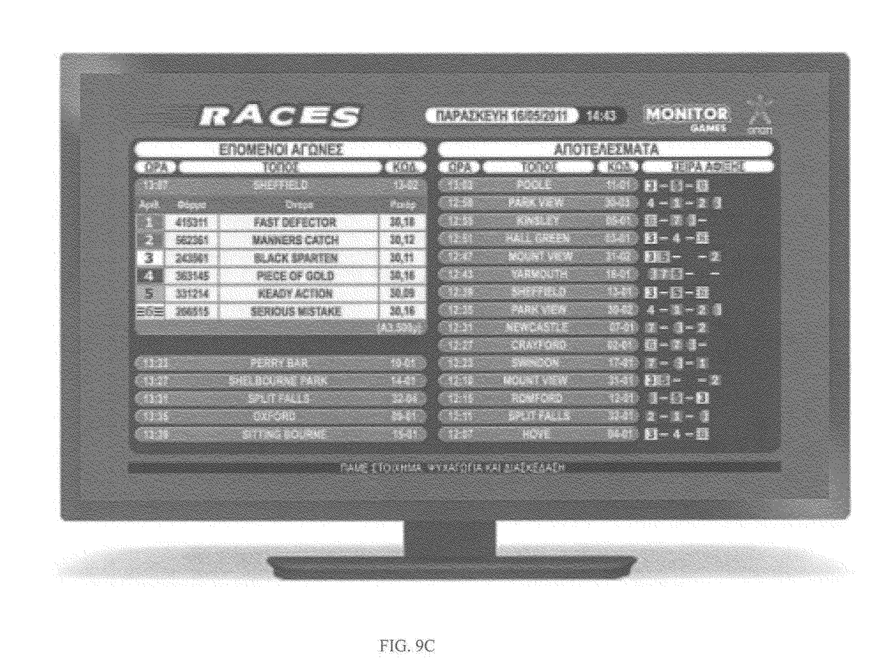

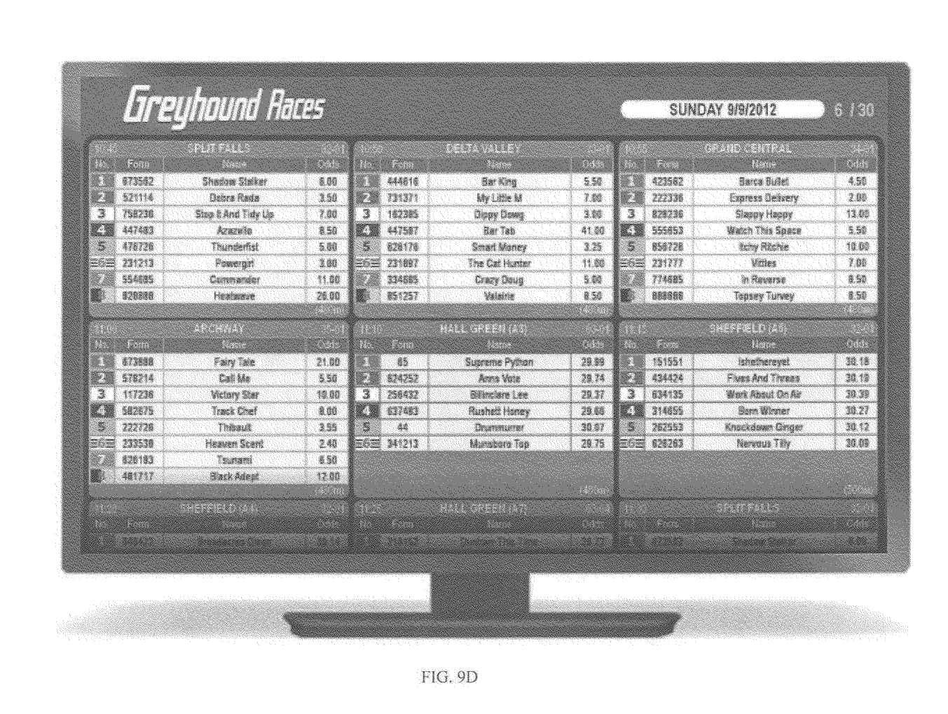

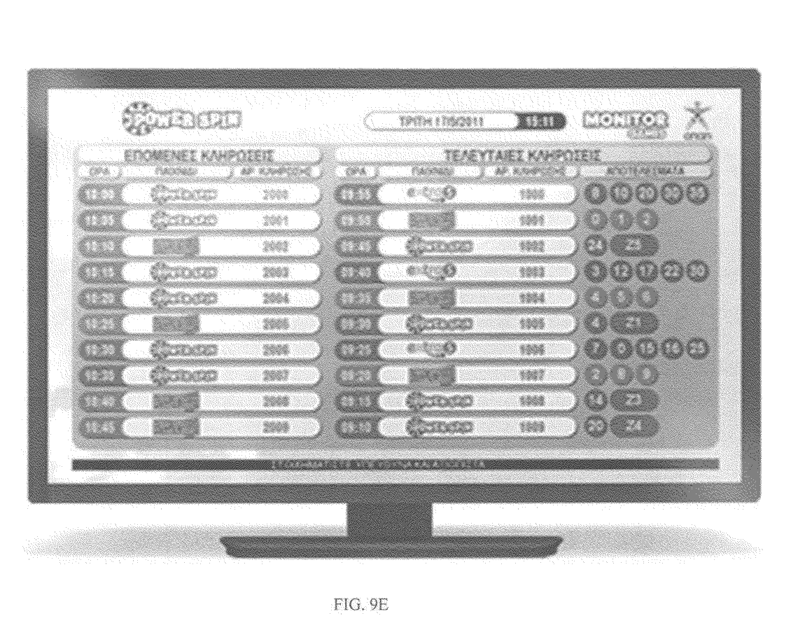

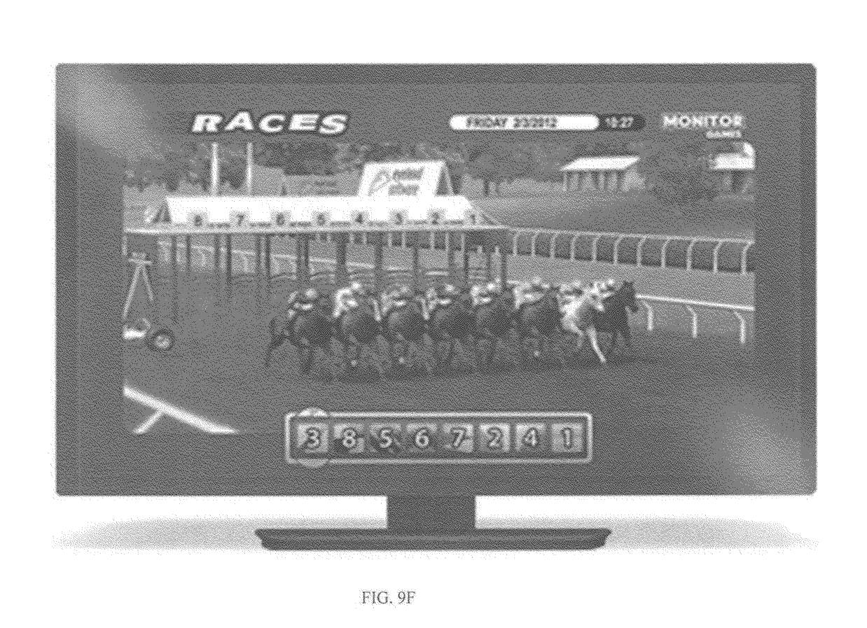

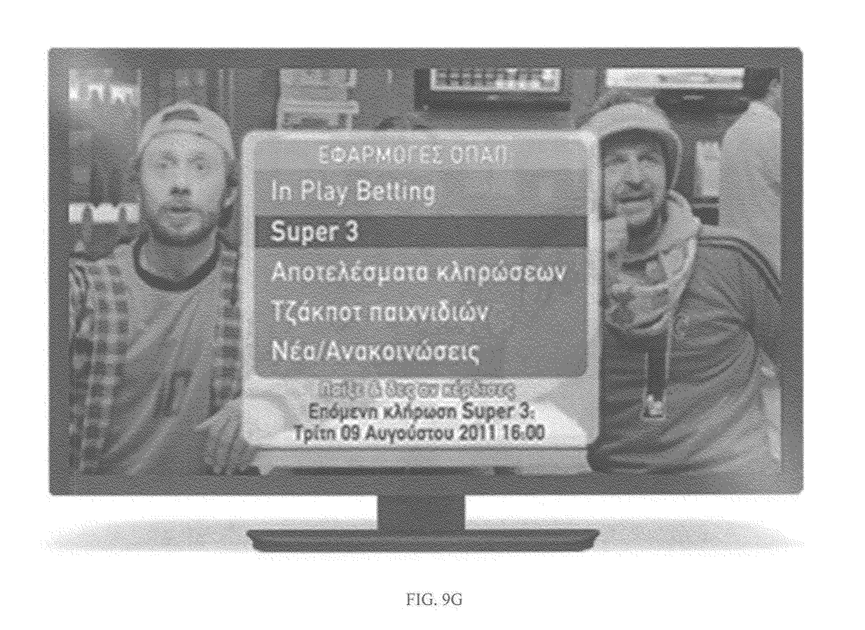

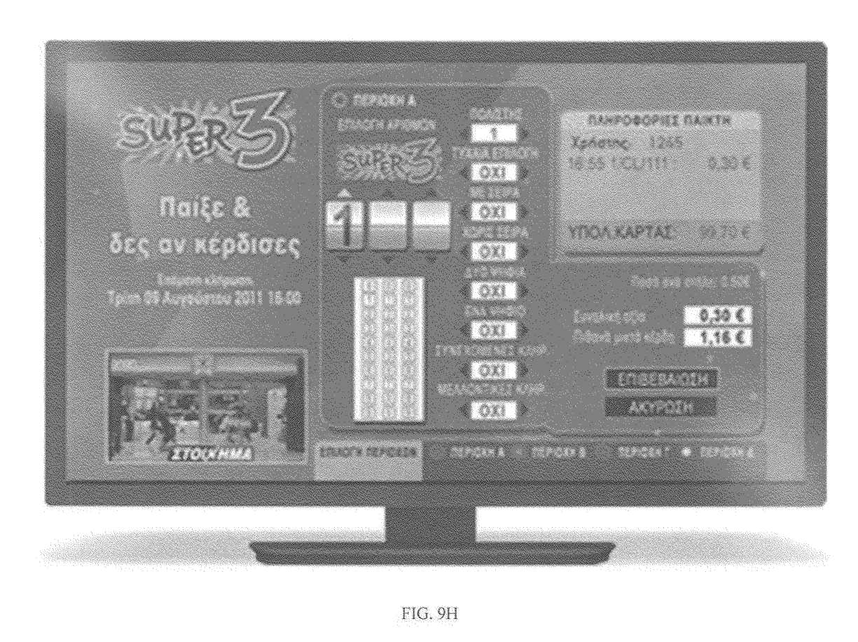

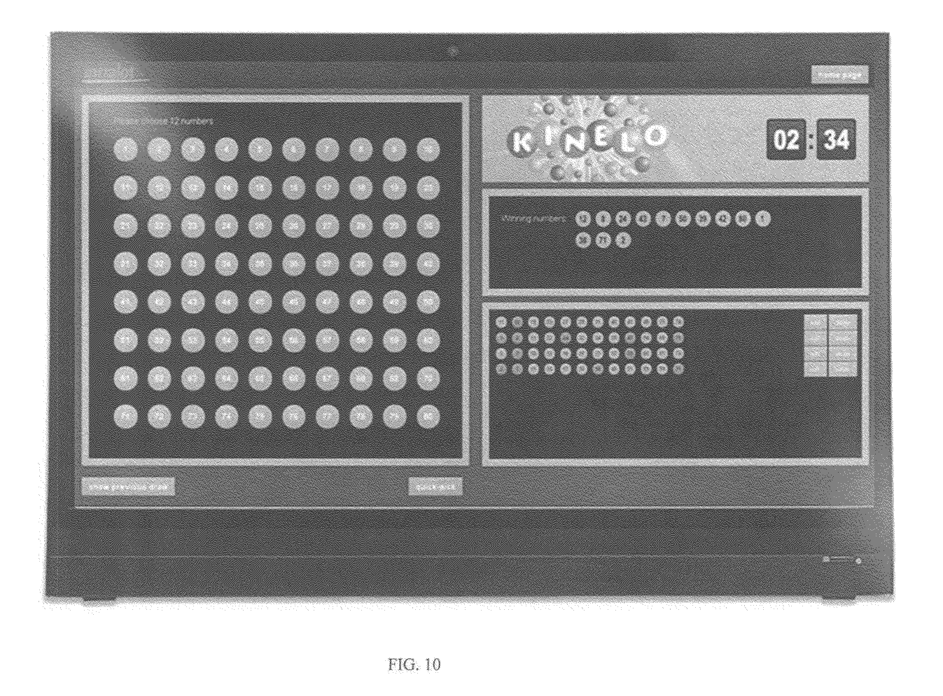

Sports Betting and Racing (e.g., FIGS. 8E, 9C-9D)
navigate conveniently in offered events info (e.g., programs, odds, results, etc.);
view added value information (e.g., statistics, standings, etc.);
sort, scroll, and/or jump to selected event;

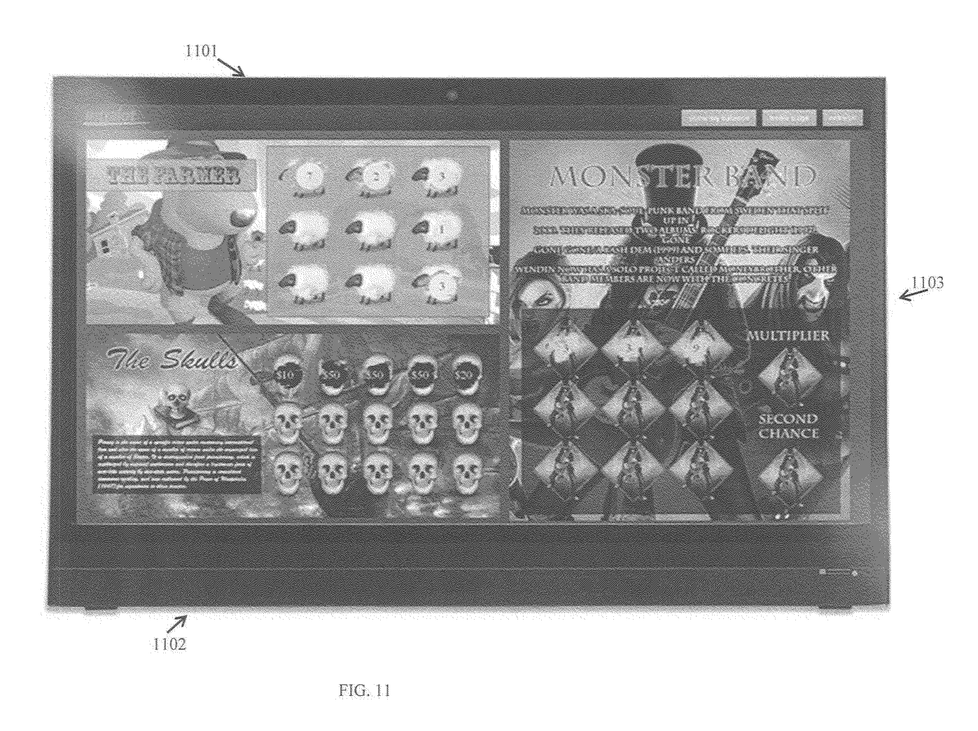

Number games (e.g., Keno (FIG. 10)), Fast games, Monitor games Virtual Games, Virtual Social Games, Virtual Races
games offered;
data feeds (e.g., results, jackpots, winners, statistical and/or historical data);
draw animations/video;
game selection;
view a live drawing;
play
display live animations;

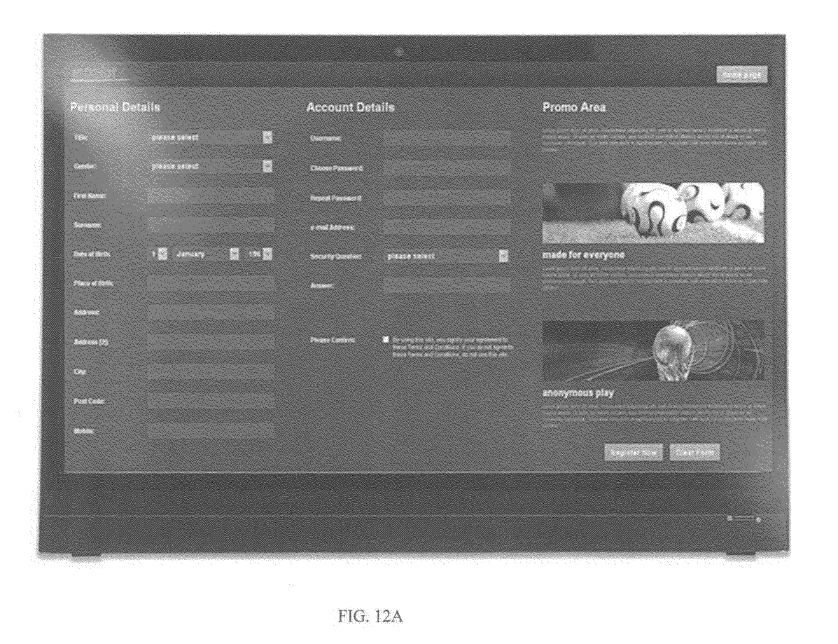

Electronic scratch games (FIG. 11)
playing a plurality of scratch games on the same screen

real “scratch” effect due to multi-touch/gesture-control

Slots

Public announcements, alerts and/or information.

In some embodiments, the player/user's identification and personalization capabilities can include various combinations/selections out of the following features:

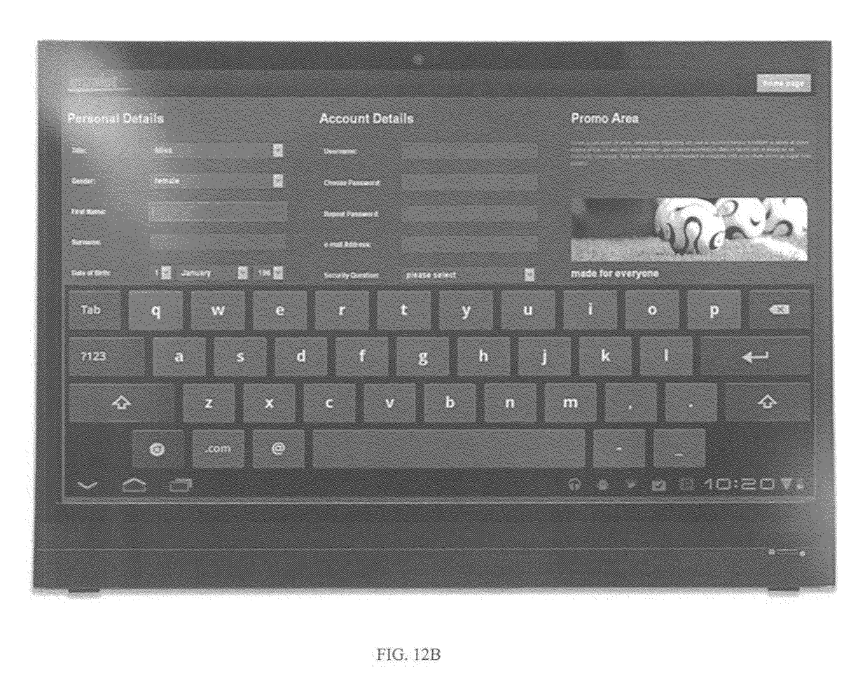

Player Identification of Registered Players/Users (FIGS. 12A-12B)
centrally managed player account across all channels (e.g., Internet, mobile, retail, etc.);
player's user-name, password, and/or club ID is entered using virtual keyboard;
player's club ID via NFC tag or NFC enabled handheld device;
view balance, winnings, played games, settings/preferences, manage account;
players/users receive receipts by e-mail and/or SMS, as per their registration profile;
in-store printing of activity (bet slips) via, for example, a USB, Wi-Fi, IR-enabled printer;

Player Identification of Non-Registered Players/Users
user/player buys a voucher (e.g., a paper slip printed by a lottery/game organizer or retailer, a prepaid card, an e-mail);
the voucher can include a QR-code, and/or a text token/player's nick-name;
user/player scans/submits the voucher by, for example, using a camera of the single interactive presentation device of the instant invention to read a voucher printed on paper or a voucher displayed on user/player's portable device (e.g., smartphone), and/or enters text token via a virtual keyboard;
setting up an anonymous account that is centrally managed, allowing the user/player to view balance, winnings, played games, set preferences, etc.;
obtaining balance/cash-out at a retailer;
receive receipts via a retailer terminal (e.g., at time of cash-out), SMS, e-mail, USB/Wi-Fi/IR printer, etc.;

Personalized Digital Signage
utilize the player's club ID to view display preferred content per player's profile;

Gaming
present the player's club ID to a central gaming/lottery system;
personalized user interface based on, for example, player's profile;

Security
secure transactions (e.g., utilizing VPN and/or encryption);
ID/username/password authentication;
timeouts for logging-out of session;

Responsible Gaming
centrally applied responsible gaming policies, based on monitoring time and amounts played; and
centrally delivered responsible gaming alerts in multimedia formats.

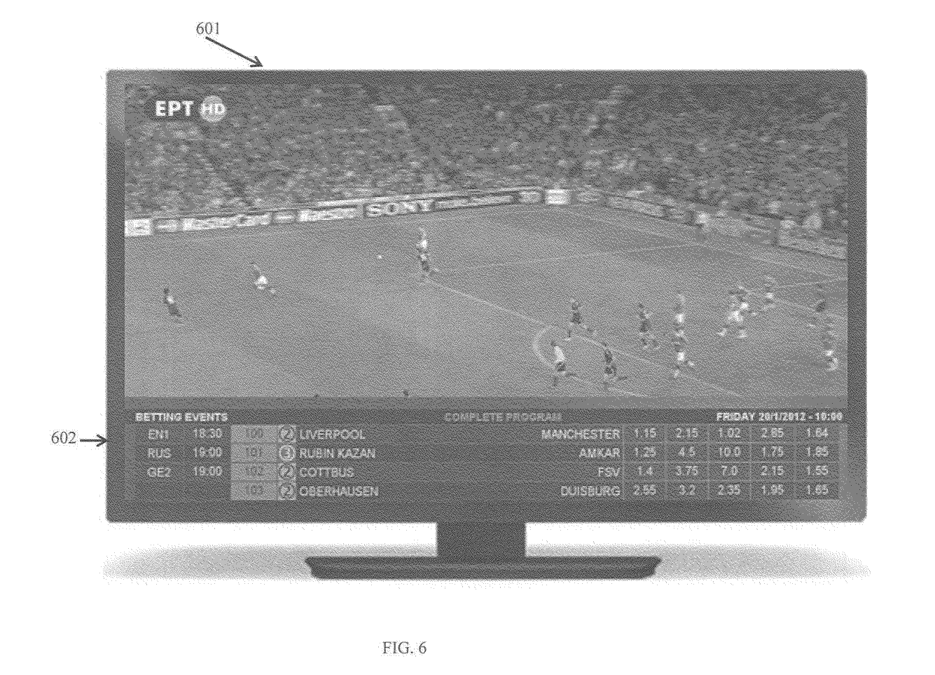

In some embodiments, a player can watch a live event and/or other live content. In some embodiments, the live event and/or other live content is related to the game offered to a participant. In some embodiments, the live event and/or other live content is related to the game offered to a participant in one or more sections of the screen. In some embodiments, the player may access information related to the game in one or more sections of the screen. As illustrated in FIG. 6, in some embodiments, a screen of the single interactive presentation device of the instant invention can have a first area (601) for a live event broadcast and a second area (602) for displaying information (e.g., games/betting-related information) and/or for the interactive (touchscreen-enabled) gaming/betting which can be related to the live event broadcast shown in the first area (601), can be unrelated, or the interactive gaming/betting content can be both: related and unrelated to what is shown in the first area (601).

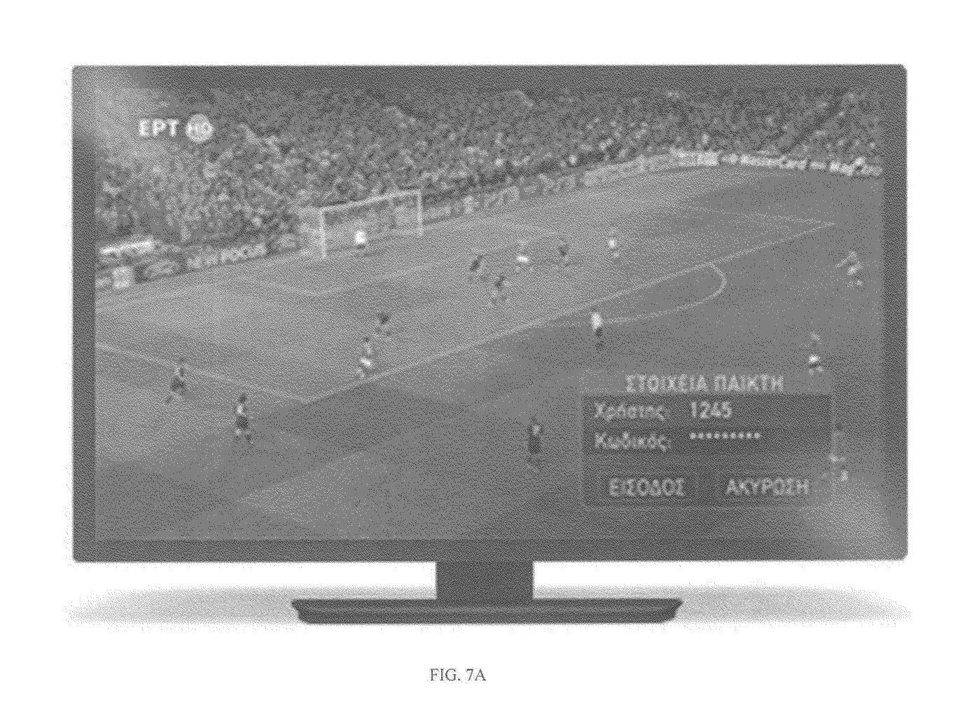

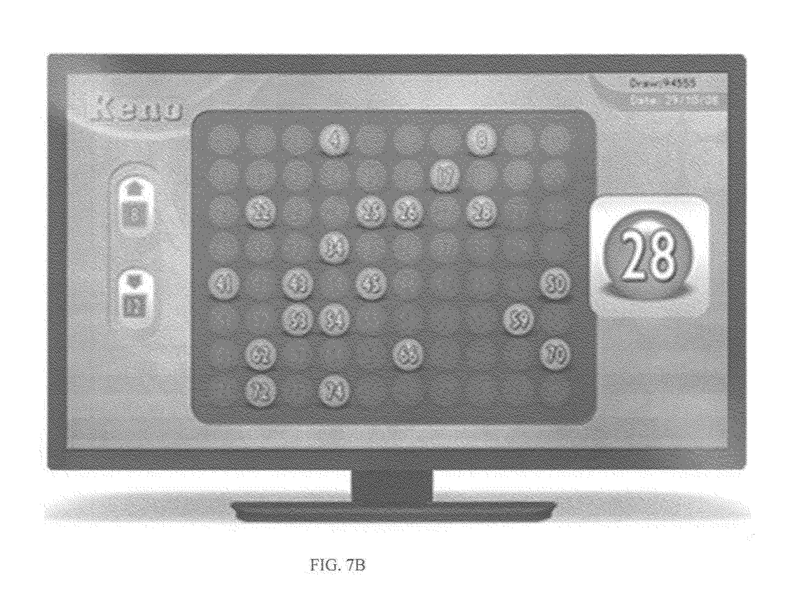

As illustrated in FIGS. 7A-7B, in some embodiments, the screen of the single interactive presentation device of the instant invention can be in a View Mode. In some embodiments, in the View mode, an event (e.g., live game) can be displayed in full screen. In some embodiments, in the View Mode (when no player is active on the device), a centrally managed content is displayed, such as:
Video: live video (sports, real/virtual races) and/or pre-stored video (e.g., game highlights);
Ticker/vertical scroller information;
Game content (e.g., fast games, monitor games, betting and racing information, etc.).

As illustrated in FIGS. 8A-8D, in some embodiments, the screen of the single interactive presentation device of the instant invention can be in a Play Mode. In some embodiment, in the Play Mode, a user/player can touch and/or gesture-control the screen to get local control of displayed content, and/or navigate conveniently to available selections, such as, but not limited to: information and/or games/betting. As illustrated in FIGS. 8A-8D, in some embodiments, the screen of the single interactive presentation device of the instant invention can allow a user/player to touch and/or gesture-control to play, while viewing the event in a smaller window. Thus, in some embodiment, in the Play Mode, the screen is split, with areas for: (1) at least first area for an event (805) (e.g., live events (sport games/activities, betting, racing, etc.), virtual racing, KENO, fast number games, monitor games, etc.) and information display and (2) at least second area for a user to play. As illustrated in FIG. 8C, in some embodiments, the screen of the single interactive presentation device of the instant invention can allow, in the Play Mode, a user/player to view and/or concurrently play/participate in, a plurality of events/games/bettings (e.g., the player's primary and side games). As illustrated in FIGS. 8D-8E, in some embodiments, the screen of the single interactive presentation device of the instant invention is split in to at least the following areas:
Live Video Feed selection area (801);
Betting Menu area (802);
Available Bets (e.g., betting selections/markets) area (803);
Bet Slip (e.g., selection confirmation) area (804); and
Live Event area (805).

In some embodiments, if no live feed is available, the single interactive presentation device of the instant invention can show data feeds (e.g., event-centers programming (e.g., regarding a sport game, the sport game-centered programming can include film-of-match, statistics, expert commentary, etc.).

In some embodiments, the single interactive presentation device of the instant invention can display centrally managed content and be monitored and controlled through a central system.

In some embodiments, a user of the single interactive presentation device of the instant invention is presented with and allowed to interactively participate (e.g., play) at the same time in several independent games and/or lottery drawings (e.g., live online games (e.g., on-line poker, Keno, progressive jackpot games, fantasy sport games), live betting) which can be related to and/or unrelated to one or more live contents (e.g., live sport events, etc.) being simultaneously presented to the user on the single interactive presentation device of a lottery/game operator. For example, in some embodiments, the user can be offered on the single interactive presentation device of the instant invention to interactively participate (e.g., place bets) in numerous markets as disclosed, inter alia, in U.S. patent application Ser. No. 13/935,996, entitled “METHODS AND SYSTEMS FOR CONDUCTING GAMES OF CHANCE” whose specific examples of numerous combinations of concurrently playing multiple gaming/lottery opportunities are incorporated herein by reference in their entirety for all related purposes discussed herein.

In some embodiments, the single interactive presentation device of the instant invention can allow a user/player to interact and view at least one of the following:
betting info/live events,
racing info/live events,
Number game results, jackpots, winners,
monitor/fast games animations,
player alerts,
social alerts,
advertisements, promotions,
public announcements and information,
targeted messages.

As illustrated in FIGS. 9A-9B, in some embodiments, the screen of the single interactive presentation device of the instant invention can allow a user/player to interactively navigate to the offered betting/racing events, utilizing the touchscreen-enabled and/or gesture-control methodologies.

As illustrated in FIGS. 9C-9D, in some embodiments, the screen of the single interactive presentation device of the instant invention can allow the user/player to interactively play/participate in the offered betting/racing events and/or games, utilizing the touchscreen-enabled and/or gesture-control methodologies. In some embodiments, the user/player can be pre-authorized (e.g., confirming membership, account information, identity confirmation, loyalty credits confirmation, etc.) utilizing the interactive touchscreen and/or gesture-control of the single interactive presentation device of the instant invention before the user/player is allowed to play/participate in the offered betting/racing events and/or games.

As illustrated in FIG. 9E, in some embodiments, the screen of the single interactive presentation device of the instant invention can allow the user/player to interactively play/participate by touching and/or gesture-controlling the screen to view, for example, game results.

As illustrated in FIG. 9F, in some embodiments, the screen of the single interactive presentation device of the instant invention can allow the user/player to interactively play/participate by touching and/or gesture-controlling the screen to view, for example, monitor games.

As illustrated in FIG. 9G, in some embodiments, the screen of the single interactive presentation device of the instant invention can allow the user/player to interactively play/participate by touching and/or gesture-controlling the screen to view, for example, monitor games.

As illustrated in FIG. 9H, in some embodiments, the screen of the single interactive presentation device of the instant invention can allow the user/player to interactively play/participate by touching and/or gesture-controlling the screen to view, for example, results of the played game.

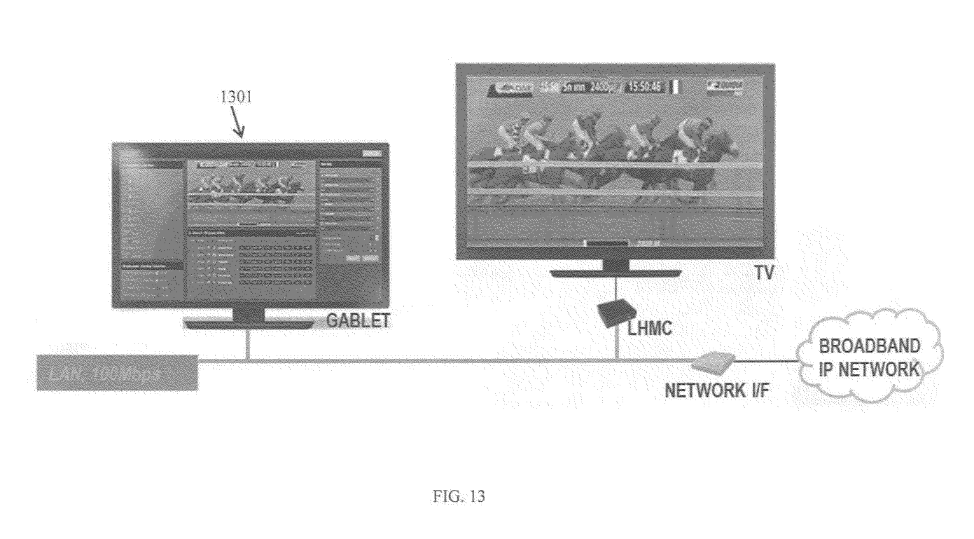

FIG. 13 illustrates how, in some embodiments, the content can be delivered over the Internet to the interactive presentation device (1301) of the instant invention that is located remotely from a central control system (e.g., central computer server(s) that are remotely managing interactive presentation devices of the instant invention) and/or another remote source.

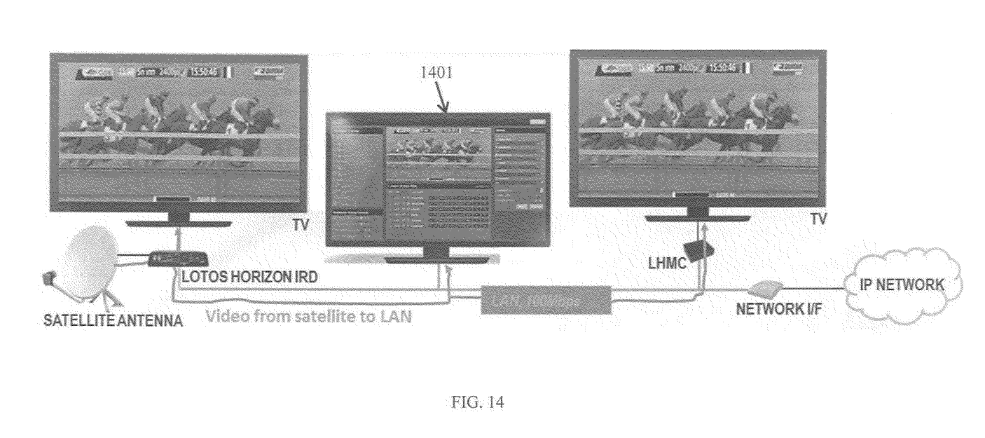

FIG. 14 illustrates how, in some embodiments, the content can be delivered over a satellite transmittal and/or the Internet to the interactive presentation device (1401) of the instant invention that is located remotely from a central control system (e.g., central computer server(s) that are remotely managing interactive presentation devices of the instant invention) and/or another remote source.

In some embodiments, the user/player can be pre-authorized (e.g., confirming membership, account information, identity confirmation, loyalty credits confirmation, etc.) utilizing the interactive touchscreen and/or gesture-control of the interactive presentation device.

In some embodiments, the live content is located in one or more sections of the screen while the information related to the game is located in one or more other sections of the screen. In some embodiments, the player may participate in the game using one or more sections of the screen. In some embodiments, the live content, information related to the game, and/or area for participating in the game are located in different sections of the screen.

In some embodiments, the system includes a human machine interface. In some embodiments, the human machine interface is based on a responsive, multi-touch and gesture-control screen interface. In some embodiments, the human machine interface includes software.

In some embodiments, the human machine interface software allows navigation of the player to the games and content. In some embodiments, the navigation of the single interactive presentation device of the instant invention may be, but is not limited to, simple touch, multi touch, press and/or gesture-based multi-touch, press and gesture-based. In some embodiments, the navigation of the single interactive presentation device of the instant invention may include, but is not limited to, one or more of the following activities:

sorting, scrolling, jumping, zooming-in/out;

accessing selection menus (e.g., “hot areas” bringing an interactive menus),

moving to next item, sizing, rotating;

text searching;

executing voice commands.

In some embodiments, the navigation is based on gestures for moving up, down, forward, and/or backward. In some embodiments, the navigation is based on gestures for accessing the previous menu or a parent menu in a tree menu hierarchy.

In some embodiments, the navigation is based on hot areas that display interactive menus when pressed. In some embodiments, the navigation is based on movable objects that follow the user finger path on the screen. In some embodiments, the navigation is based on multi touch gestures to size and/or rotate interactive elements on the screen. In some embodiments, the navigation is based on a customized interface and/or interaction profiles, based on registered player preferences.

In some embodiments, the software allows on-screen appearance of games and/or content. In some embodiments, the on-screen appearance may be vibrant and/or colorful. In some embodiments, the on-screen appearance of games and content are based on a player's actions. In some embodiments, these player actions include, but are not limited to, animation effects based on application of mathematical models following physical effects that may include, but are not limited to, damping standing waves and oscillations and/or animation effects based on application of mathematical models following projections on Cartesian space of free space moving objects.

In some embodiments, participation in games using this system may be cashless, paper-less, and/or based on secure player identification and/or central player account.

In some embodiments, the present invention includes methods and system for utilizing a computer as an advanced self-service terminal. In some embodiments, the computer is used in retailer shop environments.

In some embodiments, the computer screen size is 22″. In some embodiments, the computer screen size ranges from 20″ to 40″. In some embodiments, the computer screen size is greater than 40″. In some embodiments, the computer screen size is less than 22″. In some embodiments, the computer is a tablet computer. In some embodiments, the computer is an advanced self-service terminal for retail shop environments. In some embodiments, the retailer shop environments include lottery, betting, racing, video lottery and/or casual gaming venues.

In some embodiments, the tablet is a self service-terminal in retailer shop environments. In some embodiments, the tablet is positioned in the retailer shop environment via wall mounting, desktop placement, which may or may not be inclined, with a photo-frame stand, desktop placement on an appropriately sized pole allowing vertical inclination and horizontal rotation, and/or desktop placement in a horizontal position.

In some embodiments, the methods and system offers self-service gaming functionality in a “walled-garden” fashion. In some embodiments, the self-service gaming is dictated by the Operator/Gaming Licensee.

In some embodiments, the methods and system offer games that include, but are not limited to, lottery, betting, racing, video-lottery, casual games and/or peer-to-peer games. In some embodiments, the games are dictated by the Operator/Gaming Licensee.

In some embodiments, the methods and system offer interactive information services, including, but not limited to, information and statistics about the offered games and general purpose information that may include news and/or social alerts. In some embodiments, the interactive information services are dictated by the Operator/Gaming Licensee.

In some embodiments, the methods and system offer promotional content and/or advertisements that may include live broadcasting of gaming content events, results, draws, and/or updates. In some embodiments, the promotional content and/or advertisements may be dictated by the Operator/Gaming Licensee.

In some embodiments, the methods and system include providing an advanced human-machine interface. In some embodiments, the human machine interface includes navigation that may be based on multi-touch gestures via the tablet touch screen, text and voice-based search, and/or voice-based command and/or control.

In some embodiments, the methods and system allow secure player transactions to a central gaming system. In some embodiments, the methods and system support different central systems in an open-manner.

In some embodiments, the methods and system support video communications. In some embodiments, the video communications are supported via tablet camera or equivalent. In some embodiments, the video communications are between the player and the support call center. In some embodiments, the video communication may be peer-to-peer video communications between players engaged in peer-to-peer gaming. In some embodiments, the video communications may include communications between the player and support call center and/or peer-to-peer communications.

In some embodiments, the methods and system support, via tablet camera or equivalent, face detection, face tracking, age and/or gender recognition, and/or identity recognition.

In some embodiments, the methods and system support direct marketing. In some embodiments, the direct marketing includes targeted messages displayed on-screen and/or to player handheld devices. In some embodiments, the direct marketing targeted messages are sent to the player handheld device through Wi-Fi, Bluetooth, or other wireless communication channels offered by the tablet.

In some embodiments, the instant invention provides for a computer-implemented method that that includes at least the following steps of: presenting, by a specialized interactive presentation device, to a user, a touchscreen divided into: i) at least one first function area, ii) at least one second function area, and iii) at least one third function area; where the specialized interactive presentation device is located at a physical establishment that provides gaming, lottery, or both; where the at least one first function area, the at least one second function area, and the at least one third function area are configured to function independently from each other and concurrently with each other; displaying, by the specialized interactive presentation device, in the at least one first function area, advertisement content related to lottery, gaming, or both; displaying, by the specialized interactive presentation device, in the at least one second function area, event content for at least one live or stored event; displaying, by the specialized interactive presentation device, in the at least one third function area, at least one interactive non-lottery game, at least one interactive lottery game, or both; enabling, by the specialized interactive presentation device, the user to interact with the at least one second function area to select the event content to be displayed by the at least one second function area; where the at least one second function area is configured to receive from the user selections related to the event content, by recognizing at least one of: i) the user's touches of the touchscreen within the at least one second function area, and ii) at least one first gesture by the user related to the user's interaction with the at least one second function area; enabling, by the specialized interactive presentation device, the user to interact with the at least one third function area to play the at least one interactive non-lottery game, at least one interactive lottery game, or both; and where the at least one third function area is configured to receive from the user selections related to the at least one interactive non-lottery game, at least one interactive lottery game, or both, by recognizing at least one of: i) the user's touches of the touchscreen within the at least one third function area, and ii) at least one second gesture by the user related to the user's interaction with the at least one third function area.

In some embodiments, the method can further include personalizing for the user, by the specialized interactive presentation device, at least one of the following: i) the advertisement content, ii) the event content, iii) the at least one interactive non-lottery game, and iv) at least one interactive lottery game.

In some embodiments, the personalizating is based, at least in part, on stored profile information about the user.

In some embodiments, the personalizating is based, at least in part, on identifying data received, by the specialized interactive presentation device, from the user when the user interacts with the specialized interactive presentation device.

In some embodiments, the specialized interactive presentation device receives the identifying data, by utilizing at least one of the following: i) the touchscreen, ii) at least one camera, and iii) at least one module recognizing wireless information transmission.

In some embodiments, the at least one module is a near-field communication (NFC) reader.

In some embodiments, the personalizating is based, at least in part, on a specific interactive lottery game, a specific interactive non-lottery game, or both which the user presently plays or previously played.

In some embodiments, the method can further includes step of: combining, by the specialized interactive presentation device, at least one first content element received from at least one remote source with at least one second content element generated by the specialized interactive presentation device to create at least one of the following: i) the advertisement content, ii) the event content, iii) the at least one interactive non-lottery game, and iv) at least one interactive lottery game.

In some embodiments, the at least one second content element is generated by the specialized interactive presentation device based, at least in part, on one of the following: i) stored profile information about the user, ii) identifying data received, by the specialized interactive presentation device, from the user, and iii) at least one first interaction between the user and the specialized interactive presentation device.

In some embodiments, the event is a sport game. In some embodiments, the at least one interactive non-lottery game is a peer-to-peer game. In some embodiments, the at least one interactive lottery game is a fast number lottery game. In some embodiments, the fast number lottery game is Keno.

In some embodiments, the instant invention provides for a computer-implemented system that includes at least the following components/modules: at least one specialize computer machine, comprising: a non-transient memory having at least one region for storing particular computer executable program code; and at least one processor for executing the particular program code stored in the memory, wherein the particular program code is configured to at least perform the following operations: presenting, by a specialized interactive presentation device, to a user, a touchscreen divided into: i) at least one first function area, ii) at least one second function area, and iii) at least one third function area; where the specialized interactive presentation device is located at a physical establishment that provides gaming, lottery, or both; where the at least one first function area, the at least one second function area, and the at least one third function area are configured to function independently from each other and concurrently with each other; displaying, by the specialized interactive presentation device, in the at least one first function area, advertisement content related to lottery, gaming, or both; displaying, by the specialized interactive presentation device, in the at least one second function area, event content for at least one live or stored event; displaying, by the specialized interactive presentation device, in the at least one third function area, at least one interactive non-lottery game, at least one interactive lottery game, or both; enabling, by the specialized interactive presentation device, the user to interact with the at least one second function area to select the event content to be displayed by the at least one second function area; where the at least one second function area is configured to receive from the user selections related to the event content, by recognizing at least one of: i) the user's touches of the touchscreen within the at least one second function area, and ii) at least one first gesture by the user related to the user's interaction with the at least one second function area; enabling, by the specialized interactive presentation device, the user to interact with the at least one third function area to play the at least one interactive non-lottery game, at least one interactive lottery game, or both; and where the at least one third function area is configured to receive from the user selections related to the at least one interactive non-lottery game, at least one interactive lottery game, or both, by recognizing at least one of: i) the user's touches of the touchscreen within the at least one third function area, and ii) at least one second gesture by the user related to the user's interaction with the at least one third function area.

In some embodiments, the methods and system support responsible gaming.

While a number of embodiments of the present invention have been described, it is understood that these embodiments are illustrative only, and not restrictive, and that many modifications may become apparent to those of ordinary skill in the art. Further still, the various steps of the methods of the instant invention may be carried out in any desired order (and any desired steps may be added and/or any desired steps may be eliminated).

What is claimed is:

1. A computer-implemented method, comprising:
presenting, by a specialized interactive presentation device, to a user, a touchscreen divided into:
i) at least one first function area,
ii) at least one second function area, and
iii) at least one third function area;
wherein the specialized interactive presentation device is located at a physical establishment that provides gaming, lottery, or both;
wherein the at least one first function area, the at least one second function area, and the at least one third function area are configured to function independently from each other and concurrently with each other;
displaying, by the specialized interactive presentation device, in the at least one first function area, advertisement content related to lottery, gaming, or both;
displaying, by the specialized interactive presentation device, in the at least one second function area, event content for at least one live or stored event;
displaying, by the specialized interactive presentation device, in the at least one third function area, at least one interactive non-lottery game, at least one interactive lottery game, or both;
enabling, by the specialized interactive presentation device, the user to interact with the at least one second function area to select the event content to be displayed by the at least one second function area;
wherein the at least one second function area is configured to receive from the user selections related to the event content, by recognizing at least one of:
i) the user's touches of the touchscreen within the at least one second function area, and
ii) at least one first gesture by the user related to the user's interaction with the at least one second function area;
enabling, by the specialized interactive presentation device, the user to interact with the at least one third function area to play the at least one interactive non-lottery game, at least one interactive lottery game, or both; and
wherein the at least one third function area is configured to receive from the user selections related to the at least one interactive non-lottery game, at least one interactive lottery game, or both, by recognizing at least one of:
i) the user's touches of the touchscreen within the at least one third function area, and
ii) at least one second gesture by the user related to the user's interaction with the at least one third function area.

2. The method of claim 1, wherein the method further comprises:
personalizing for the user, by the specialized interactive presentation device, at least one of the following:
i) the advertisement content,
ii) the event content,
iii) the at least one interactive non-lottery game, and
iv) at least one interactive lottery game.

3. The method of claim 2, wherein the personalizating is based, at least in part, on stored profile information about the user.

4. The method of claim 2, wherein the personalizating is based, at least in part, on identifying data received, by the specialized interactive presentation device, from the user when the user interacts with the specialized interactive presentation device.

5. The method of claim 4, wherein the specialized interactive presentation device receives the identifying data, by utilizing at least one of the following:
i) the touchscreen,
ii) at least one camera, and
iii) at least one module recognizing wireless information transmission.

6. The method of claim 5, wherein the at least one module is a near-field communication (NFC) reader.

7. The method of claim 2, wherein the personalizating is based, at least in part, on a specific interactive lottery game, a specific interactive non-lottery game, or both which the user presently plays or previously played.

8. The method of claim 1, wherein the method further comprises:
combining, by the specialized interactive presentation device, at least one first content element received from at least one remote source with at least one second content element generated by the specialized interactive presentation device to create at least one of the following:
i) the advertisement content,
ii) the event content,
iii) the at least one interactive non-lottery game, and
iv) at least one interactive lottery game.

9. The method of claim 8, wherein the at least one second content element is generated by the specialized interactive presentation device based, at least in part, on one of the following:
i) stored profile information about the user,
ii) identifying data received, by the specialized interactive presentation device, from the user, and
iii) at least one first interaction between the user and the specialized interactive presentation device.

10. The method of claim 1, wherein the event is a sport game.

11. The method of claim 1, wherein the at least one interactive non-lottery game is a peer-to-peer game.

12. The method of claim 1, wherein the at least one interactive lottery game is a fast number lottery game.

13. The method of claim 1, wherein the fast number lottery game is Keno.

14. A computer system, comprising:
at least one specialize computer machine, comprising:
a non-transient memory having at least one region for storing particular computer executable program code; and
at least one processor for executing the particular program code stored in the memory,
wherein the particular program code is configured to at least perform the following operations:
presenting, by a specialized interactive presentation device, to a user, a touchscreen divided into:
i) at least one first function area,
ii) at least one second function area, and
iii) at least one third function area;
wherein the specialized interactive presentation device is located at a physical establishment that provides gaming, lottery, or both;
wherein the at least one first function area, the at least one second function area, and the at least one third function area are configured to function independently from each other and concurrently with each other;
displaying, by the specialized interactive presentation device, in the at least one first function area, advertisement content related to lottery, gaming, or both;
displaying, by the specialized interactive presentation device, in the at least one second function area, event content for at least one live or stored event;
displaying, by the specialized interactive presentation device, in the at least one third function area, at least one interactive non-lottery game, at least one interactive lottery game, or both;
enabling, by the specialized interactive presentation device, the user to interact with the at least one second function area to select the event content to be displayed by the at least one second function area;
wherein the at least one second function area is configured to receive from the user selections related to the event content, by recognizing at least one of:
i) the user's touches of the touchscreen within the at least one second function area, and
ii) at least one first gesture by the user related to the user's interaction with the at least one second function area;
enabling, by the specialized interactive presentation device, the user to interact with the at least one third function area to play the at least one interactive non-lottery game, at least one interactive lottery game, or both; and
wherein the at least one third function area is configured to receive from the user selections related to the at least one interactive non-lottery game, at least one interactive lottery game, or both, by recognizing at least one of:
i) the user's touches of the touchscreen within the at least one third function area, and
ii) at least one second gesture by the user related to the user's interaction with the at least one third function area.

15. The computer system of claim 14, wherein the method further comprises:
personalizing for the user, by the specialized interactive presentation device, at least one of the following:
i) the advertisement content,
ii) the event content,
iii) the at least one interactive non-lottery game, and
iv) at least one interactive lottery game.

16. The computer system of claim 15, wherein the personalizating is based, at least in part, on stored profile information about the user.

17. The computer system of claim 15, wherein the personalizating is based, at least in part, on identifying data received, by the specialized interactive presentation device, from the user when the user interacts with the specialized interactive presentation device.

18. The computer system of claim 17, wherein the specialized interactive presentation device receives the identifying data, by utilizing at least one of the following:
i) the touchscreen,
ii) at least one camera, and
iii) at least one module recognizing wireless information transmission.

19. The computer system of claim 18, wherein the at least one module is a near-field communication (NFC) reader.

20. The computer system of claim 15, wherein the personalizating is based, at least in part, on a specific interactive lottery game, a specific interactive non-lottery game, or both which the user presently plays or previously played.

21. The computer system of claim 14, wherein The computer system further comprises:
combining, by the specialized interactive presentation device, at least one first content element received from at least one remote source with at least one second content element generated by the specialized interactive presentation device to create at least one of the following:
i) the advertisement content,
ii) the event content,
iii) the at least one interactive non-lottery game, and
iv) at least one interactive lottery game.

22. The computer system of claim 21, wherein the at least one second content element is generated by the specialized interactive presentation device based, at least in part, on one of the following:
i) stored profile information about the user,
ii) identifying data received, by the specialized interactive presentation device, from the user, and
iii) at least one first interaction between the user and the specialized interactive presentation device.

23. The computer system of claim 14, wherein the event is a sport game.

24. The computer system of claim 14, wherein the at least one interactive non-lottery game is a peer-to-peer game.

25. The computer system of claim 14, wherein the at least one interactive lottery game is a fast number lottery game.

26. The computer system of claim 14, wherein the fast number lottery game is Keno.
